(19) United States
(12) Patent Application Publication
(10) Pub. No.: US 2024/0151413 A1
(43) Pub. Date: May 9, 2024

(54) AIR PURIFIER WITH FILTER RETAINER

(71) Applicant: FELLOWES, INC., Itasca, IL (US)

(72) Inventors: Michael EGAN, Chicago, IL (US); Shawn M. APPLEGATE, Streamwood, IL (US); James Edward LOSSER, St. Charles, IL (US); John S. BOYADJIAN, Mount Prospect, IL (US); Tai Hoon K. MATLIN, Round Lake Beach, IL (US); Peter M. MALETICH, Vancouver, WA (US); Mateusz KUBAK, Carol Stream, IL (US); Ahmednoor KANSARA, Morton Grove, IL (US)

(21) Appl. No.: 18/377,299

(22) Filed: Oct. 5, 2023

Related U.S. Application Data
(60) Provisional application No. 63/414,120, filed on Oct. 7, 2022.

(51) Int. Cl. F24F 8/80; B01D 39/20; F24F 8/108; F24F 8/22; F24F 13/28

(52) U.S. Cl. CPC F24F 8/80; F24F 8/108; F24F 13/28; B01D 39/2062; F24F 8/22

(57) ABSTRACT

An air purifier comprises a housing that comprises an intake opening for an inflow of air and an output opening for an outflow of air, a fan, a motor for rotating the fan, a sleeve configured to at least partially surround the fan and/or the motor, an air purifier unit, and a retainer assembly. The air purifier unit is mounted in the housing purifying air flowing through the housing and is operatively coupled to the sleeve. The retainer assembly is configured to retain the air purifier unit in the housing and with respect to the sleeve. The retainer assembly comprises a retainer and an actuator operatively associated with the retainer and the sleeve, wherein movement of the actuator from a first position to a second position moves the retainer to securely retain the air purifier unit in the housing.

This application claims the benefit under 35 USC 119(e) of prior co-pending U.S. Provisional Patent Application Ser. No. 63/414,120, filed Oct. 7, 2022, which is hereby incorporated by reference in its entirety.

### BACKGROUND

### Field

The present patent application relates to air purifiers, and particularly an air purifier and/or air purifiers that include a filter retainer.

### Description of Related Art

Airborne dust and allergens such as pollen, mold spores, pet dander, and micro-organisms (e.g., germs and bacteria) may affect the health of persons breathing the air. Air purifiers are well known devices that are used in interior spaces such as homes and commercial public spaces for providing fresh air by removing odors, dust, allergens and other airborne pollutants from the interior air.

The air purifier generally includes a housing with an air inlet and an air outlet. The air inlet is configured to receive ambient air and the air outlet is configured to deliver purified air into the interior space. The housing provides an airflow path from the air inlet to the air outlet. The housing also includes an air filtering system, a fan and a drive mechanism (e.g., a motor). The air filtering system is provided in the airflow path for filtrating contaminants present in ambient air passing therethrough. The fan is configured to move the air through the airflow path between the air inlet and the air outlet. The drive mechanism is configured to provide power to draw air into the air inlet, to draw air through the airflow path and to exhaust purified air out of the air outlet.

Examples of known air purifiers include U.S. Pat. No. 9,737,842 (“the '842 Patent”) titled “air purifier with intelligent sensors and airflow”; U.S. Design Patent Nos.: U.S. D667097 titled “air purifier”; U.S. D667098 titled “air purifier” and U.S. D667096 titled “air purifier”; and U.S. Patent Application Publication No.: 2018/0154297 titled “air purifier with intelligent sensors and airflow”. These patents and/or patent application are commonly owned by the same assignee as the present patent application. The present patent application incorporates each of these patents and/or patent application by reference in their entirety.

The present patent application endeavors to provide various improvements over known air purifiers or air purifying systems.

### SUMMARY

In one embodiment of the present patent application, an air purifier is provided. The air purifier comprises a housing, a fan, a motor for rotating the fan, a sleeve configured to at least partially surround the fan and/or the motor, an air purifier unit, and a retainer assembly. The housing comprises an intake opening for an inflow of air and an output opening for an outflow of air. The air purifier unit is mounted in the housing purifying air flowing through the housing. The air purifier unit is operatively coupled to the sleeve. The retainer assembly is configured to retain the air purifier unit in the housing and with respect to the sleeve. The retainer assembly comprises a retainer and an actuator operatively associated with the retainer and the sleeve. Movement of the actuator from a first position to a second position moves the retainer to securely retain the air purifier unit in the housing.

In one embodiment, in use, the air purifier unit is essentially co-axial to the fan and/or the motor.

In one embodiment, the air purifier may include a dual core configuration having two fans, two motors, two air purifier units, and two retainer assemblies. In each core of the dual core configuration, the air purifier unit is essentially co-axial to the associated fan and/or the associated motor.

These and other aspects of the present patent application, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise. It should also be appreciated that some of the components and features discussed herein may be discussed in connection with only one (singular) of such components, and that additional like components which may be disclosed herein may not be discussed in detail for the sake of reducing redundancy.

Other aspects, features, and advantages of the present patent application will become apparent from the following detailed description, the accompanying drawings, and the appended claims.

### BRIEF DESCRIPTION OF THE DRAWINGS

Various embodiments are disclosed, by way of example only, with reference to the accompanying schematic drawings in which corresponding reference symbols indicate corresponding parts, in which

FIG. 1 shows a perspective view of an exemplary air purifier in accordance with an embodiment of the present patent application, where the air purifier includes a dual module/core/air channel configuration and the air purifier is hanging from a ceiling using cables;

FIG. 2 shows a perspective view of the air purifier of FIG. 1, where a side panel of the air purifier is moved (from its closed position in FIG. 1) to its open position, for example, for installing/replacing a filter/an air purifier unit;

FIG. 3 shows an exploded view of the air purifier of FIG. 1;

FIG. 4 shows another exploded view of the air purifier of FIG. 1, where some portions (such as housing, sensor, controller, etc.) of the air purifier are not shown to better illustrate other portions of the air purifier;

FIG. 5 shows a single module/core configuration of an exemplary air purifier in accordance with an embodiment of the present patent application, where some portions (such as housing, sensor, controller, etc.) of the air purifier are not shown to better illustrate other portions of the air purifier;

FIG. 6 shows double/dual module/core configuration of the air purifier of FIG. 1, where some portions (such as housing, sensor, controller, etc.) of the air purifier are not shown to better illustrate other portions of the air purifier;

FIG. 7 shows an assembled view of an exemplary retainer assembly of an air purifier unit in an air purifier in accordance with an embodiment of the present patent application;

FIG. 8 shows an exploded view of the retainer assembly of FIG. 7;

FIGS. 9-16 show various exemplary procedures in a method for installing/replacing an air purifier unit in an air purifier in accordance with an embodiment of the present patent application, where FIGS. 9-10 show exemplary procedures for connecting a carbon filter and a High-Efficiency Particulate Absorption (HERA) filter of the air purifier unit to each other, FIGS. 11-12 show exemplary procedures for aligning/supporting the air purifier unit using a filter guide to enable the air purifier unit to be in position with respect a sleeve (configured to at least partially surround the fan and/or the motor) before actuating an actuator of the retainer assembly to securely retain the air purifier unit, and FIGS. 13-16 show exemplary procedures for retaining, using the retainer assembly, the air purifier unit in the housing and with respect to the sleeve;

FIG. 17 shows various views of an exemplary retainer assembly (e.g., spring plate retainer assembly/mechanism) for an air purifier unit of an air purifier in accordance with another embodiment of the present patent application;

FIG. 18 shows various views of an exemplary retainer assembly (e.g., lever retainer mechanism/assembly) for an air purifier unit of an air purifier in accordance with another embodiment of the present patent application;

FIG. 19 shows various views of an exemplary retainer assembly (e.g., tab engagement retainer assembly/mechanism) for an air purifier unit of an air purifier in accordance with another embodiment of the present patent application;

FIG. 20 shows various views of an exemplary retainer assembly (e.g., spring based and tapered retainer assembly/mechanism) for an air purifier unit of an air purifier in accordance with another embodiment of the present patent application;

FIG. 21 shows a prior art air purifier unit/filter;

FIG. 22 shows various views of an exemplary retainer assembly (e.g., spring biased retainer assembly/mechanism) for an air purifier unit/filter of an air purifier in accordance with another embodiment of the present patent application;

FIG. 23 shows an exemplary mixed flow fan used in an air purifier in accordance with an embodiment of the present patent application;

FIG. 24 shows the exemplary mixed flow fan of FIG. 23 being disposed in a sleeve in the air purifier;

FIG. 25 shows portions of the housing of an air purifier in accordance with an embodiment of the present patent application, where a sleeve (configured to at least partially surround a fan and/or a motor), the motor, the mixed flow fan, and an outlet/exit flow guide structure are shown;

FIG. 26 shows portions of an air purifier in accordance with another embodiment of the present patent application, where a mixed flow fan, a motor, and an outlet/exit flow guide structure are shown;

FIG. 27 shows an exemplary filter to fan simulation in accordance with an embodiment of the present patent application;

FIG. 28 shows comparative graphical representations of pressure vs airflow through an air purifier, for example, when a centrifugal fan, a mixed flow fan or an axial fan is used in the air purifier;

FIG. 29 shows a prior art graphical representation of pressure vs airflow through an air purifier when an axial fan is used in the air purifier;

FIG. 30 shows a shared core configuration (e.g., including an air purifier unit/filter, a mixed flow fan, an outlet/exit flow guide structure, and a retainer assembly for the air purifier unit/filter) being used across different models/configurations of the air purifiers including on and in ceiling, hanging from ceiling, on and in wall, and floor standing configurations;

FIGS. 31-33 show exemplary prototypes of an air purifier in accordance with an embodiment of the present patent application, where FIG. 31 shows an air purifier with a single core/module configuration, FIG. 32 shows an air purifier with dual core/module configuration, and FIG. 33 shows the air purifier with the dual core/module configuration in which a filter access panel is moved to an open position for installation or replacement of an air purifier unit/filter; and

FIGS. 34-35 show exemplary air purifiers in accordance with an embodiment of the present patent application, where FIG. 34 shows an air purifier with a single core/module configuration and FIG. 35 shows an air purifier with dual core/module configuration.

### DETAILED DESCRIPTION OF THE DRAWINGS

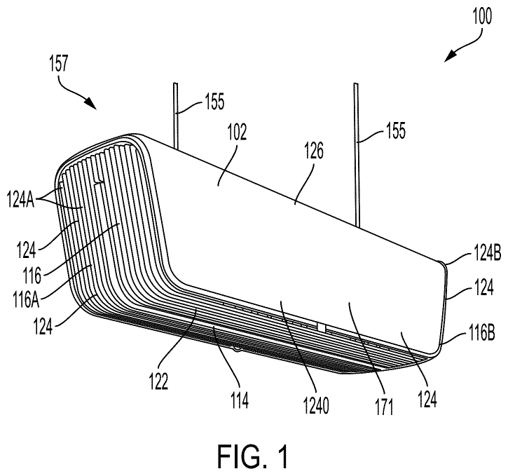

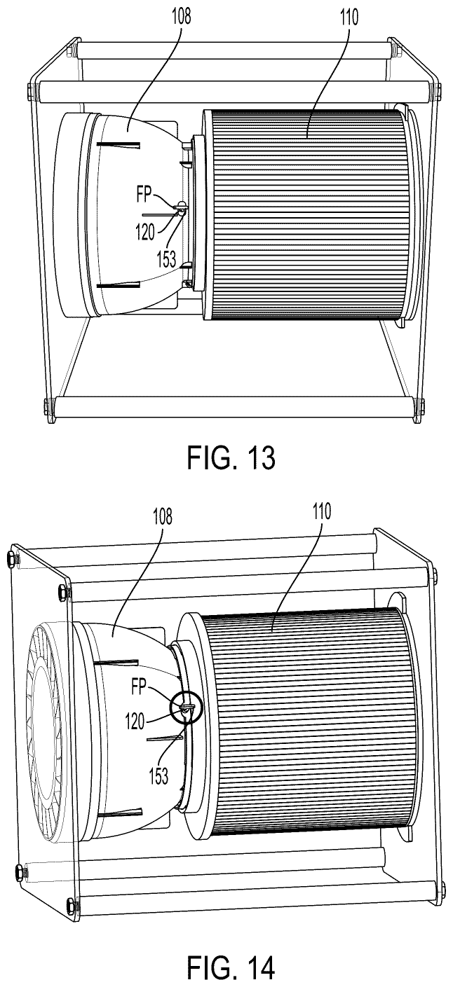

FIGS. 1-6 show an air purifier 100. In one embodiment, the air purifier 100 comprises a housing 102, a fan 104, a motor 106 for rotating the fan 104, a sleeve 108 configured to at least partially surround the fan 104 and/or the motor 106, an air purifier unit 110, and a retainer assembly 112. The housing 102 comprises an intake opening 114 for an inflow of air and an output opening 116 for an outflow of air. The air purifier unit 110 is mounted in the housing 102 purifying air flowing through the housing 102 and is operatively coupled to the sleeve 108. The retainer assembly 112 is configured to retain the air purifier unit 110 in the housing 102 and with respect to the sleeve 108. The retainer assembly 112 comprises a retainer 118 and an actuator 120 operatively associated with the retainer 118 and the sleeve 108. Movement of the actuator 120 from a first position FP (as shown in FIGS. 13 and 14) to a second position SP (as shown in FIG. 16) moves the retainer 118 to securely retain the air purifier unit 110 in the housing 102.

The housing 102 may include an elongated housing. The housing 102 may include a base 122, a plurality of side walls 124, and a top 126. In one embodiment, at least three of the plurality of side walls 124, the base 122, the top 126 together define an interior cavity 123 of the air purifier 100. The interior cavity 123 may be configured to receive various components of the air purifier 100 (including the motor 106, the fan 104, the retainer assembly 112, and the air purifier unit 110) therein. The fourth side wall 124 of the housing 102 may be movably attached to the housing 102 and may serve as a filter access panel 171 as will be described in detail below.

The base 122 may be perforated to include intake opening 114 for the inflow of air. The intake opening 114 may be interchangeably referred to as air inlet and may be configured to receive ambient air. The intake opening 114 may include a plurality of intake openings. The intake opening 114 is positioned proximate the air purifier unit 110 as will be described in detail in the discussions below.

At least one of the plurality of side walls 124 includes the output opening 116 for the outflow of air. The output opening 116 may be interchangeably referred to as air outlet and may be configured to deliver purified air. The housing 102 also provides the air flow path between the intake opening 114 and the output opening 116.

The housing 102 may also include outlet louvers 128 provided adjacent the outlet opening 116. The outlet louvers 128, as would be appreciated by a person of ordinary skill in the art (POSITA), are configured to efficiently guide or direct the purified air, which is being discharged from the housing 102, through the outlet opening 116 and after the air purification, into the environment surrounding the air purifier 100. The louvers 128 may guide or direct the purified air into locations (in the environment surrounding the air purifier 100) that are different from locations (in the environment surrounding the air purifier 100) from which the ambient air is received into the housing 102 via the intake opening 114.

Portions of the housing 102 may be formed from a suitable molded plastic material. Portions of the housing 102 may be formed from sheet metal, aluminum or other metal materials. Portions of the housing 102 may be formed from a combination of a plastic material and a metal material.

The base 122, the plurality of side walls 124, and the top 126 of the housing 102 may be connected to each other to form peripheral surfaces/walls with the intake openings 114 on the base 122 and the outlet openings 116 on at least one of the side walls 124. That is, the base 122, the plurality of side walls 124, and the top 126 of the housing 102 may be connected to each other together to form at least a portion of the air flow path of the air purifier 100 between the intake opening 114 and the output opening 116.

The air purifier 100 may include a single core configuration or a dual core configuration. Both the single core configuration and the dual core configuration of the air purifier 100 will be described in detail below. In a dual core configuration, as shown in FIGS. 1-3, the air purifier 100 may include two output openings 116A, 116B for the outflow of air on a first pair of opposing side walls 124A, 124B. Portions of a second pair of opposing side walls 124C, 124D may form panels. One of these panels is fixed to the housing 102 and the other of these panels may be configured to hingeably (e.g., using friction hinges or other types of hinges 169) or movably connected to the top 126 or other portions of the housing 102. A POSITA would appreciate that, in a friction hinge, pressure may be applied against at least one of a fixed component of the hinge and a movable component (e.g., attached to the panel) of the hinge to produce friction in the hinge and to resist rotational movement of the panel about an axis of a shaft connecting the fixed and movable component. In another embodiment, both the panels may be movably connected to the housing 102. The movable panel may be referred to as panel 171 or filter access panel and will be described in detail below.

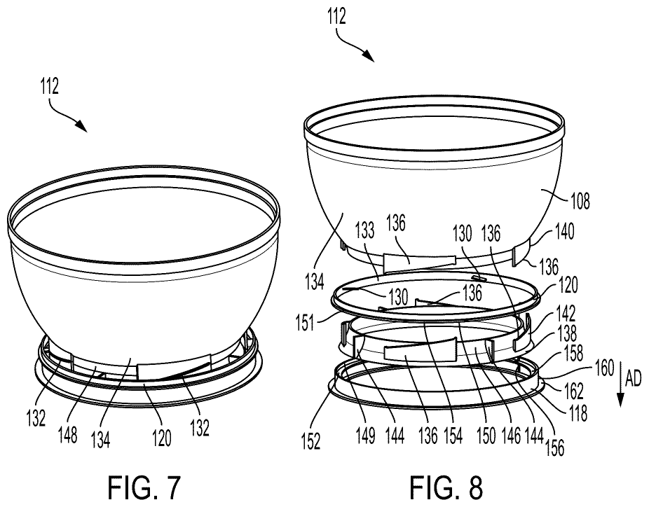

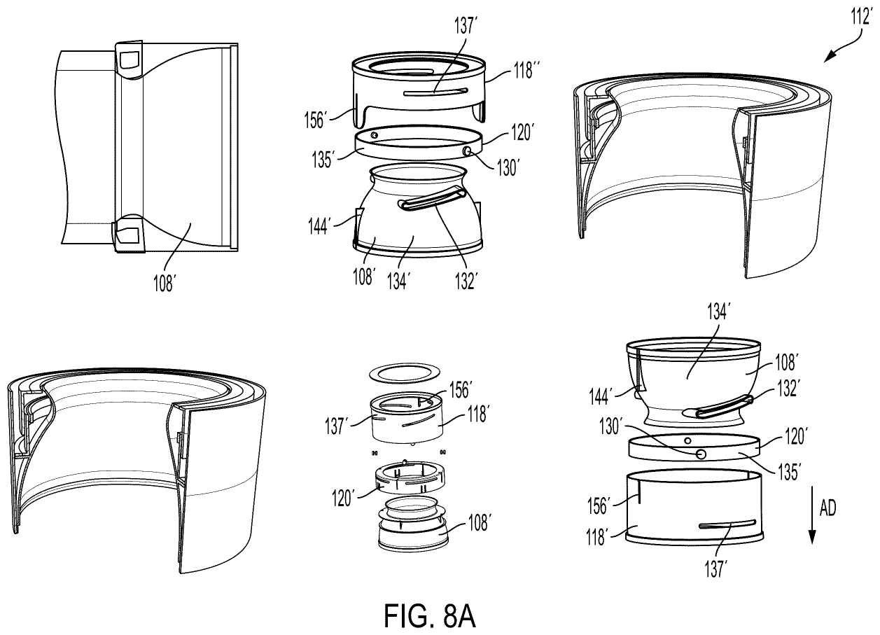

FIGS. 7 and 8 show the retainer assembly 112 that is configured to retain the air purifier unit 110 in the housing 102 and with respect to the sleeve 108. FIG. 7 shows an assembled view of the retainer assembly 112 of the air purifier 100, while FIG. 8 shows an exploded view of the retainer assembly 112. In FIGS. 7 and 8, the sleeve 108 and a guide ring 138 are fixed to and with respect to the housing 102 of the air purifier 100, while the actuator 120 and the retainer 118 are movable with respect to the sleeve 108 and the guide ring 138. The actuator 120 and the retainer 118 are movable with respect to the housing 102 of the air purifier 100. The guide ring 138 in the embodiment of FIG. 8 differs from the embodiment of FIG. 8A. The guide ring 138 in FIG. 8 is assembled to the sleeve 108. Therefore, the guide ring 138 does not move after being assembled to the sleeve 108. As will be clear from the discussions below, the guide ring 138 forms the angled guide path 132 for the actuator 120. The twisting or rotational movement of the actuator 120 may cause an axial movement of the actuator 120 and the retainer 118 by camming action of the actuator 120 in the angled guide path 132.

FIG. 8A show another retainer assembly 112′ in which guide/track 132′ is disposed on the sleeve 108 or another part on or that remains fixed with respect to the housing and a separate guide ring (such as guide ring 138 of FIGS. 7-8) is not included. The sleeve 108′ is fixed to the housing of the air purifier, while the actuator 120′ and the retainer 118′ are movable with respect to the sleeve 108′ and with respect to the housing of the air purifier. Retainer 118′ of FIG. 8A may extends the entire axial length of the sleeve 108, while retainer 118″ of FIG. 8A may extend the entire axial length of the sleeve 108 at some portions, and does not extend the entire height of the sleeve 108 at other portions. Retainer 118′ and 118″ of FIG. 8A have slightly different configurations than the retainer 118 of FIGS. 7 and 8. Other than these differences and some other differences noted in detail below, the retainer assembly 112′ of FIG. 8A is substantially similar to the retainer assembly 112 of FIGS. 7 and 8 in terms of configuration and function.

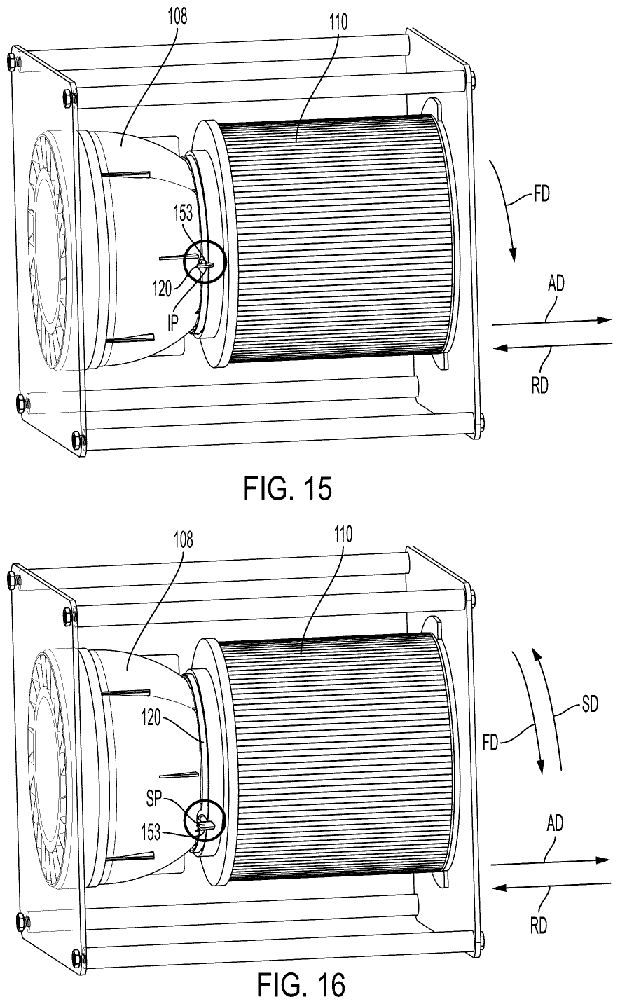

The retainer assembly 112 includes the retainer 118 and the actuator 120 that is operatively associated with the retainer 118 and the sleeve 108. Movement of the actuator 120 from the first position FP (as shown in FIGS. 13 and 14) to the second position SP (as shown in FIG. 16) moves the retainer 118 to securely retain the air purifier unit 110 in the housing 102. The actuator 120 may include one or more intermediate positions IP (as shown in FIG. 15) between the first position FP and the second position SP.

The actuator 120 may be an actuator ring having a ring/annular shaped configuration. The actuator 120 may include an engagement member 130 disposed thereon. The engagement member 130 may be a pin or a protrusion that is disposed on an inner circumferential surface 133 of the actuator 120. The engagement member 130 may be configured to face the sleeve 108.

As will be clear from the detailed discussions below, the engagement member 130 is configured to engage with a guide/track 132 disposed on the sleeve 108 and/or the guide ring 138 as the actuator 120 is being moved from the first position FP (as shown in FIGS. 13 and 14) to the second position SP (as shown in FIG. 16) so as to advance/move the retainer 118 to securely retain the air purifier unit 110 in the housing 102. The engagement and/or movement of the engagement member 130 of the actuator 120 in the guide 132 disposed on the sleeve 108 and/or the guide ring 138 enables operative association between the actuator 120 and the sleeve 108.

The engagement member 130 of the actuator 120 may be one of a plurality of engagement members 130 that are disposed at regular intervals on the inner circumferential surface 133 of the actuator 120. For example, as shown in FIG. 8A, the actuator 120 may include two engagement members 130′ that are disposed at 180 degree intervals on the inner circumferential surface of the actuator 120′. In another embodiment, as shown in FIG. 8, the actuator 120 may include four engagement members 130 that are disposed at 90 degree intervals on the inner circumferential surface 133 of the actuator 120. In yet another embodiment, the actuator 120 may include three engagement members that are disposed at 120 degree intervals on the inner circumferential surface of the actuator 120. The number of engagement members 130 may vary. As will be described in detail below, the number of engagement members 130 matches with the number of guides 132 disposed on the sleeve 108 and/or the guide ring 138.

In one embodiment, as shown in FIG. 8A, the engagement member 130′ may also extend/protrude outwardly from an outer (peripheral/circumferential) surface 135′ of the actuator 120′ so as to engage with a guide/track 137′ of the retainer 118′. The movement of the inner portion of the engagement member 130′ of the actuator 120′ in the guide 132′ of the sleeve 108′ and the movement of the outer portion of the engagement member 130′ of the actuator 120′ in the guide/track 137′ of the retainer 118′ enables the advancement of the retainer 118′ (in the direction of AD).

The engagement member 130′ of the actuator 120′ in the guide 132′ of the sleeve 108′ may be a cam follower that is cammed axially during circumferential rotation. The outer portion of the engagement member 130′ of the actuator 120′ may be a separate part. The outer portion of the engagement member 130′ of the actuator 120′ may be configured to connect to the retainer 118′ without having the retainer 118′ rotate (which would cause a high amount of friction as the retainer 118′ is pressed against the air purifier unit/filter 110).

As shown in FIGS. 7 and 8, the actuator 120 may be configured to be movable/rotatable with respect to both the sleeve 108 and the guide ring 138, which are fixed to the housing 102 of the air purifier 100. As shown in FIG. 8A, the actuator 120′ may be configured to be movable/rotatable with respect to the sleeve 108′, which is fixed to the housing 102 of the air purifier 100.

The actuator 120 may also include a flange portion 150 that is configured to be received in a receiver portion 152 of the retainer 118. The flange portion 150 is being disposed on a lower portion 154 of the actuator 120.

Referring to FIGS. 12-16, the actuator 120 may also include a manually engageable actuator tab 153 fixed thereon. The manually engageable actuator tab 153 is configured to be manually engaged by the user such that the engagement and movement of the manually engageable actuator tab 153 by the user causes the actuator 120 of the air purifier 100 to be moved between its second position (as shown in FIG. 16) and its first position (as shown in FIGS. 13-14). For example, when the manually engageable actuator tab 153 is moved in a first circumferential direction FD (as shown in FIG. 16), this causes the actuator 120 of the air purifier 100 to be moved from its first position (as shown in FIGS. 13-14) to its second position (as shown in FIG. 16). When the manually engageable actuator tab 153 is moved in a second circumferential direction SD (as shown in FIG. 16), this causes the actuator 120 of the air purifier 100 to be moved from its second position (as shown in FIG. 16) to its first position (as shown in FIGS. 13-14). Both the second direction SD and the first direction FD are shown in FIG. 16 and the second direction SD is opposite to the first direction FD. For example, one of the second direction SD and the first direction FD may be a clockwise direction, while the other of the second direction SD and the first direction FD may be a counterclockwise direction.

In one embodiment, the sleeve 108 is configured to at least partially surround the fan 104 and/or the motor 106. In such an embodiment, the fan 104 and the motor 106 may each have their own separate housings, may together be disposed in a separate housing, or may separately or together be disposed in the housing 102 (i.e., in the main housing without their own housing(s)) of the air purifier 100.

In another embodiment, the sleeve 108 may be referred to as a fan and motor housing that is configured to at least partially receive the fan 104 and the motor 106 therein. In yet another embodiment, the sleeve 108 may be referred to as a fan housing that is configured to at least partially receive the fan 104 therein. In such an embodiment, the motor 106 may have a separate housing or may be disposed in the housing 102 (i.e., in the main housing without its own housing(s)) of the air purifier 100.

The sleeve 108 may be referred to as a collet or an outlet collet. The sleeve 108 may have a frustoconical or a truncated cone configuration (e.g., with peripheral surfaces having some curvature along the axial or longitudinal direction). The truncated cone shape configuration of the sleeve 108 may enable the sleeve 108 to at least partially surround/receive the motor 106 and/or the fan 104. The sleeve 108 may configured to be fixed with respect to the housing 102 of the air purifier 100.

The retainer assembly 112 further comprises the guide/track 132. In one embodiment, as shown in FIG. 8, a portion (or a half) 140 of the guide 132 is disposed on the outer (peripheral) surface 134 of the sleeve 108 and a portion (or the other half) 142 of the guide 132 is disposed on the guide ring 138 such that the portion 140 of the sleeve 108 and the portion 142 of the guide ring 138 are configured to form the guide 132 (e.g., angled guide path). As shown in FIGS. 8 and 8A, the guide 132, 132′ may be disposed near the lower portion (e.g., see 148 of FIG. 8) of the sleeve 108′.

The track/guide 132 may be interchangeably referred to as cam guides. The track/guide 132 may be linear or closer to linear. The track/guide 132 may be angled with respect to the longitudinal axis of the housing 102. The track/guide 132 may be more like a helix segment. The track/guide 132 may be following a part of helix (i.e., a segment of helix).

The guide 132 is configured to receive the engagement member 130 of the actuator 120 therein such that the engagement member 130 slidably engages with surfaces 136 of the guide 132 during the movement of the actuator 120 between the first position FP (as shown in FIGS. 13-14) to the second position SP (as shown in FIG. 16).

There may be a plurality of guides 132 that are disposed at regular circumferential intervals on the sleeve 80 and/or the guide ring 138. For example, as shown in FIG. 8A, there may be two guides 132′ that are disposed at 180 degree intervals on the sleeve 108′. In another embodiment, as shown in FIG. 8, there may be four engagement members 130 that are disposed at 90 degree intervals on the sleeve 80 and/or the guide ring 138. In yet another embodiment, there may be three guides 132 that are disposed at 120 degree intervals on the sleeve 80 and/or the guide ring 138. The number of guides 132 may vary. The number of guides 132 on the sleeve 80 and/or the guide ring 138 matches with the number of engagement members 130 on the actuator 120.

The guide ring 138 may have a ring shaped configuration or annular configuration. The guide ring 138 may be configured to be fixed with respect to the sleeve 108. The guide ring 138 and the sleeve 108 are fixed with respect to the housing 102 of the air purifier 100. The actuator 120 may be configured to be movable/rotatable with respect to the sleeve 108 and/or the guide ring 138. As noted above, and described with respect to FIG. 8A, the guide ring may be optional and the track 132′ is disposed on an outer (peripheral) surface 134′ of the sleeve 108′.

As shown in FIG. 8, the guide ring 138 may have guide portions 144 on disposed on an outer surface 146 thereon. The fixed configuration of the guide ring 138 with respect to the housing 102 and/or the sleeve 108 is configured to enable guide slots 156 in the retainer 118 to properly engage with and be guided by the guide ribs/portions 144 of the guide ring 138. This facilitates the axial movement of the retainer 118 with respect to (and towards and away from) the guide ring 138.

The guide portions 144 are configured to engage with associated guide slots 156 in the retainer 118 so as to enable the advancement/movement (e.g., in the direction AD) of the retainer 118 as the actuator 120 is being moved from the first position FP (as shown in FIGS. 13-14) to the second position SP (as shown in FIG. 16) and to enable the retraction/movement (e.g., in the direction opposite to direction AD) of the retainer 118 as the actuator 120 is being moved from the second position SP (as shown in FIG. 16) to the first position FP (as shown in FIGS. 13-14).

The guide portions 144 may be positioned at regular intervals on the outer surface 146 of the guide ring 138 and may be positioned between two adjacent guides 132. FIGS. 7 and 8 show four guide portions 144 on the guide ring 138 and corresponding four guide slots 156 in the retainer 118. The number of guide portions 144 of the guide ring 138 and the number of guide slots 156 of the retainer 118 may vary. The number of guide portions 144 of the guide ring 138 matches with the number of guide slots 156 of the retainer 118.

In another embodiment, as shown in FIG. 8A, guide portions 144′ may be disposed on the outer surface 134′ of the sleeve 108′. The guide portions 144′ are configured to engage with associated guide slots 156′ in the retainer 118′ so as to enable the advancement/movement (e.g., in the direction AD) of the retainer 118′ as the actuator 120′ is being moved from the first position FP (as shown in FIGS. 13-14) to the second position SP (as shown in FIG. 16) and to enable the retraction/movement (e.g., in the direction opposite to direction AD) of the retainer 118′ as the actuator 120′ is being moved from the second position SP (as shown in FIG. 16) to the first position FP (as shown in FIGS. 13-14). The guide portions 144′ may be positioned at regular intervals on the outer surface 134′ of the sleeve 108′ and between two adjacent guides 132′. FIG. 8A shows two guide portions 144′ on the sleeve 108′ and may be positioned corresponding two guide slots 156′ in the retainer 118′. The number of guide portions 144′ may vary. The number of guide portions 144′ of the sleeve 108′ matches with the number of guide slots 156′ of the retainer 118′.

The receiver portion 152 of the retainer 118 is configured to receive the flange portion 150 of the actuator 120. The receive portion 152 is disposed on a portion 158 (i.e., upper on the retainer 118 in the illustrated embodiment of FIG. 8, and thus opposite in direction to the direction AD) of the retainer 118.

The portion 160 (i.e., lower on the retainer 118 in the illustrated embodiment of FIG. 8, and thus in the direction AD) of the retainer 118 include a flange portion 162. The flange portion 162 of the retainer 118 is configured to engage with portions of the air purifier unit 110 so as to retain the air purifier unit 110 in the housing 102 and with respect to the sleeve 108.

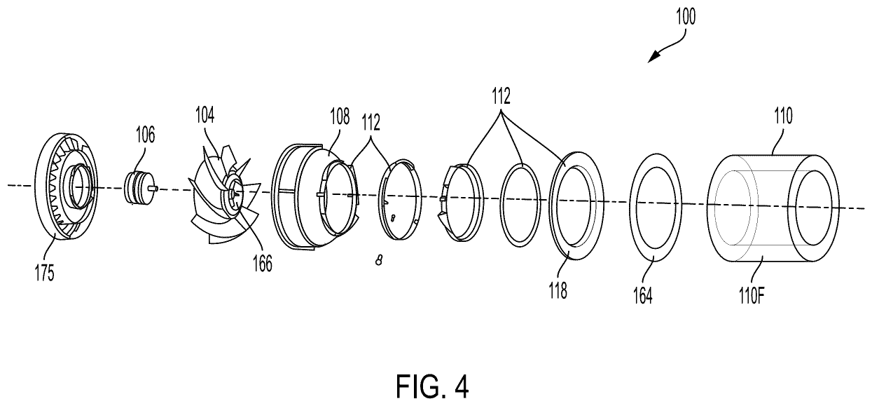

The movement of the actuator 120 between the first position FP (as shown in FIGS. 13 and 14) and the second position SP (as shown in FIG. 16) is a rotational movement. That is, rotation of the actuator 120 from the first position FP (as shown in FIGS. 13 and 14) to the second position (as shown in FIG. 16) advances/moves the retainer 118 (in the direction AD) against a portion of the air purifier unit 110 to securely retain the air purifier unit 110 in the housing 102 and with respect to the sleeve 108. The portion of the air purifier unit 110 is a sealing portion 164 (as shown in FIG. 4). The sealing/seal portion 164 is a gasket seal.

When the actuator 120 is in the first position FP (as shown in FIGS. 13 and 14), the retainer 118 is in a first position in which the retainer 118 does not engage with the air purifier unit 110. When the actuator 120 is moved to the second position SP (as shown in FIG. 16), the retainer 118 is moved to a second position in which the retainer 118 securely retains the air purifier unit 110 in the housing 102 of the air purifier 100 and with respect to the sleeve 108.

The retainer 118 is a compression ring that is configured to securely retain the air purifier unit 110. The compression ring may be configured to impart a frictional force sufficient to prevent the air purifier unit from being pulled away of the sleeve 108. The actuator 120 is rotatably mounted with respect to the sleeve 108 so as to engage with the compression ring 118 and to press the compression ring 118 against the air purifier unit 110. The rotation of the actuator 120 with respect to the sleeve 108 cams the actuator 120 towards the compression ring 118 so as to retain the air purifier unit 110. The sealing function is provided by compression.

When the actuator 120 of the air purifier 100 is being moved in a first direction FD (as shown in FIG. 16) from its first position (as shown in FIGS. 13-14) to its second position (as shown in FIG. 16), the engagement members 130 of the actuator 120 are configured to travel along the surfaces 136 of the guide/track 132 that is disposed on the sleeve 108 and/or the guide ring 138 to facilitate the movement of the actuator 120 from its first position to its second position. This movement of the engagement members 130 of the actuator 120 along the guide/track 132 causes the actuator 120 to also axially advance (in the direction AD and) away from the sleeve 108. This advancement of the actuator 120 further causes the retainer 118 to be also axially advanced in the direction AD away from the sleeve 108 as the guide ring 138 does not move with the actuator 120 and as the guide ring 138 is assembled to the sleeve 108. This configuration of the guide ring 138, the actuator 120, and the sleeve 108 create/form the guides 132 (e.g., the angular camming ramps) in which the pins 130 of actuating ring 120 ride within.

That is, due to this camming action, the retainer 118 is moved from a first axial position to a second axial position. The second axial position is spaced at a great axial distance from the sleeve 108 than the first axial position. The movement of the retainer 118 between the first axial position and the second axial position may be guided by the engagement between the guide portions 144 of the guide ring 138 (or the guide portion 144′) and the guide slots 156 in the retainer 118 (or the guide slots 156′). In one embodiment, when in the second axial position, the retainer 118 may be configured to engage with the inner surfaces of the air purifier unit 110 using friction fit engagement therebetween so as to retain the air purifier unit 110 in position.

When the actuator 120 of the air purifier 100 is being moved in the second direction SD (as shown in FIG. 16) from its second position (as shown in FIG. 16) to its first position (as shown in FIGS. 13-14), the engagement members 130 of the actuator 120 are configured to travel along the surfaces 136 of the guide/track 132 that is disposed on the sleeve 108 and/or the guide ring 138 to facilitate the movement of the actuator 120 from its second position to its first position.

This movement of the engagement members 130 of the actuator 120 along the guide/track 132 causes the actuator 120 to axially retract in the direction RD towards the sleeve 108. This retraction of the actuator 120 further causes the retainer 118 to be also axially retracted in the direction RD towards the sleeve 108 as there is no camming action between the surfaces of the actuator 120 and the retainer 118. This axial retraction of the retainer 118 away from the air purifier unit 110 causes the release of the air purifier unit 110 from the retainer 118 (and the retainer assembly 112).

The air purifier unit 110 may be mounted in the housing 102 for filtering air flowing through the housing 102 and flowing in the air flow path between the intake opening 114 and the output opening 116 of the air purifier 100. The air purifier unit 110 may include a filter 110F. The retainer assembly 112 is configured to retain the filter 110F in the housing 102 and with respect to the sleeve 108.

The air purifier unit 110 may include annular or tubular shaped configuration, such as a cylindrical tube-shape. The fan 104 may be disposed adjacent to the annular air purifier unit 110F so as to draw unclean/ambient air from the surrounding environment into and through the air inlets 114 through the annular filter/air purifier unit 110F.

The annular filter/air purifier unit 110 may include an outer particulate pre-filter for removal of a first sized particles and an inner HEPA filter for removal of different, second sized particles. The annular filter/air purifier unit 110 may include an outermost particulate pre-filter for removal of a first sized particles, an inner HEPA filter for removal of different, second sized particles and an innermost carbon (or activated carbon) filter for removal of third sized particles that are different sized than the first and second sized particles. As would be appreciated by a person of ordinary skill in the art, the first sized particles are bigger than the second sized particles, which are bigger than the third sized particles. UV lamps may be positioned inside the filter/air purifier unit 110 or near the intersection of the filter/air purifier unit 110 and the fan 104 and motor 106. Purified air stream is discharged, after filtration, through the air exhaust louvers, then is returned to the environment.

The filter 110F may include any porous material or component configured for removing particles, contaminants, impurities, solid particles, odors, dust, allergens and other airborne pollutants from the air passed through it. The filter 110F may be interchangeably referred to as air filtering media/component or air purifying component. The air purifier 100 may be configured to receive different types of filtering media, different types of air purifying components, or different types of air filtering media and air purifying components.

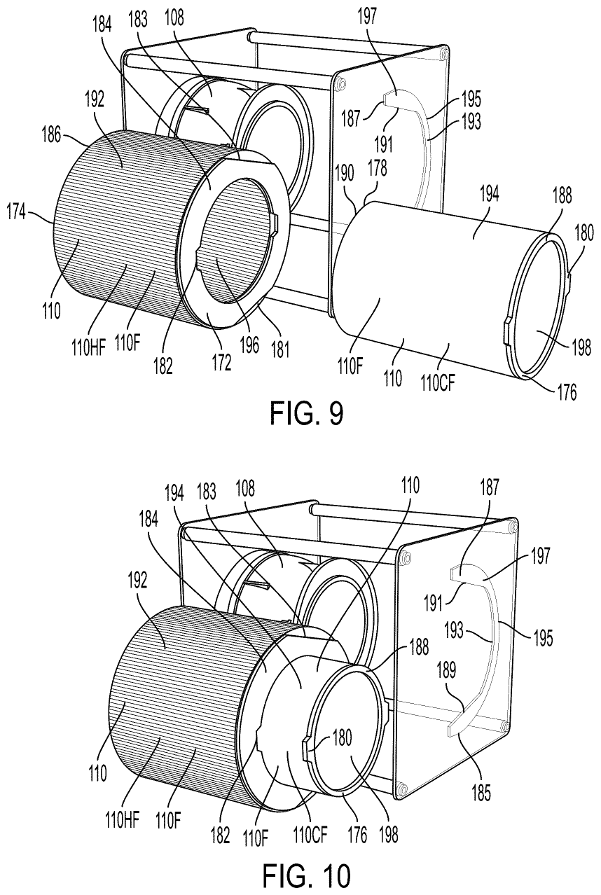

Referring to FIGS. 9-10, the air purifier unit 110 may include a High Efficiency Particulate air (HEPA) filter 110HF and a carbon filter 110CF. Although the filter 110F includes the HEPA filter 110HF and the carbon filter 110CF in FIGS. 9 and 10, a POSITA would readily appreciate that the filter 110F may include any additional filter(s) (e.g., pre-filter) or other filters or other combination of filters.

The HEPA filter 110HF may include H13 HEPA with a 1 year filter life. The carbon filter 110CF may have 6 months filter life. The filter 110F may also be configured to create an ionized field so as to purify the air. The filter 110F may have any type of filter media and/or purification technologies such as Thermodynamic Sterilization technology, Ultraviolet germicidal irradiation technology, HEPA filter, Ultra-Violet Photocatalytic Oxidation (UVPCO) technology, Electrostatic technology, Activated carbon filter, Photocatalytic Oxidation technology, Titanium dioxide (TiO₂) technology, Ionizer purifying technology, Ozone generator technology, etc. For example, the filter 110F may include two or more UV-C lamps. The filter 110F may include a filter having a Minimum Efficiency Reporting Value (MERV) that generally ranges from about MERV-13+ to MERV-17+. The filter 110F may include a granular/granulated (not pellets) activated carbon filter. The filter 110F may include activated carbon filter with 1 year filter life. Thus, an air purifier unit 110 in the system may be filter-based, may use non-filter based approaches, or a may be a combination of both, and is known class of structural devices that removed impurities from air.

The filter 110F may include a pre-filtering component, an activated carbon filtering component, a MERV-13+ filtering component or a True HEPA (MERV-17+) filtering component, two or more UV-C lamps, and a Photocatalytic air purifying component (e.g., TiO₂). The filter 110F may also include a plasma (ionizer) air purifying component. The True HEPA filtering component of the filter 110F may also include an anti-microbial agent. The pre-filter or pre-filtering component may meet ISO 16890 standard, which establishes an efficiency classification system of air filters for general ventilation based upon particulate matter (PM).

In use, the air purifier unit 110/the filter 110F is essentially co-axial with the fan 104 and/or with the motor 106. In use, the HEPA filter 110HF and the carbon filter 110CF of the air purifier unit 110/the filter 110F is essentially co-axial with the fan 104 and/or with the motor 106.

Referring to FIGS. 9 and 10, the HEPA filter 110HF of the filter 110F has first and second opposing ends 172, 174. The HEPA filter 110HF may include first and second opposing end caps 184, 186 at the first and second ends 172, 174 with the tubular, for example, cylindrical, construction of filter media 192 (e.g., corrugated) extending therebetween. The construction of the filter media 192 defines an open filter interior 196, which also corresponds to a dean air conduit/plenum, in use. The tubular construction of the filter media 192 is secured (or bonded) to the end caps 184, 186. The HEPA filter 110HF may also include an inner support tube or liner and an outer support tube or liner. Each of the inner and outer liners helps to provide structural integrity or support to the filter media 192.

The carbon filter 110CF of the filter 110F has a first and second opposing ends 176, 178. The carbon filter 110CF may include first and second opposing end caps 188, 190 at the first and second ends 176, 178 with the tubular, preferably cylindrical, construction of filter media 194 (e.g., corrugated) extending therebetween. In one embodiment, the second end cap 190 of the carbon filter 110CF may be optional and the filter media 194 may extend from and be secured to the first end cap 188. The construction of the filter media 194 defines an open filter interior 198, which also corresponds to a clean air conduit/plenum, in use. The tubular construction of the filter media 194 is secured (or bonded) to either one end cap 188 or both end caps 188, 190. The carbon filter 110CF may also include an inner support tube or liner and an outer support tube or liner. Each of the inner and outer liners helps to provide structural integrity or support to the filter media 194. The end caps may interchangeably referred to as keying rings.

The first end 172 of the HEPA filter 110HF and the first end 176 of the carbon filter 110CF are aligned with each other when the HEPA filter 110HF and the carbon filter 110CF are being connected to each other.

The first end 176 of the carbon filter 110CF may include a first mating portion 180 disposed on its first end cap 188. The first mating portion 180 may be configured to engage with a second mating portion 182 disposed on the first end cap 184 (at the first end 172) of the HEPA filter 110H so as to (e.g., removably or permanently) connect the HEPA filter 110HF and the carbon filter 110CF together. The mating portions 180, 182 may have any shaped configurations so as to enable a connection between the HEPA filter 110HF and the carbon filter 110CF. In the illustrated embodiment, in FIGS. 9-10, the mating portions 180, 182 include male and female mating portions.

The connection between the HEPA filter 110HF and the carbon filter 110CF may be facilitated by other retainer structures/mechanisms, such as, but not limited to, a snap fit structure/mechanism, a friction fit structure/mechanism, a latch mechanism, a spring detent mechanism, etc.

The connection between the HEPA filter 110HF and the carbon filter 110CF may be a removable connection when one of the filters 110HF, 110CF has a shorter life span the other of the filters 110HF, 110CF so that the shorter life span filter may be easily removed and replaced. The connection between the HEPA filter 110HF and the carbon filter 110CF may be a permanent connection when both the filters have the same life span in which case both the HEPA filter 110HF and the carbon filter 110CF may be replaced together at the same time.

The second end 174 of the HEPA filter 110HF and the second end 178 of the carbon filter 110CF are aligned with each other when the HEPA filter 110HF and the carbon filter 110CF are being connected to each other. The retainer assembly 112 is configured to retain the filter 110F (including the HEPA filter 110HF and the carbon filter 110CF in the illustrated embodiment of FIGS. 9 and 10) in the housing 102 and with respect to the sleeve 108. The retainer assembly 112 is configured to engage with either the end cap 186 (at the second end 174) of the HEPA filter 110HF or with the end caps 186, 190 (at the second ends 174, 178) of the HEPA filter 110HF and the carbon filter 110CF so as to retain the filter 110F in the housing 102 and with respect to the sleeve 108.

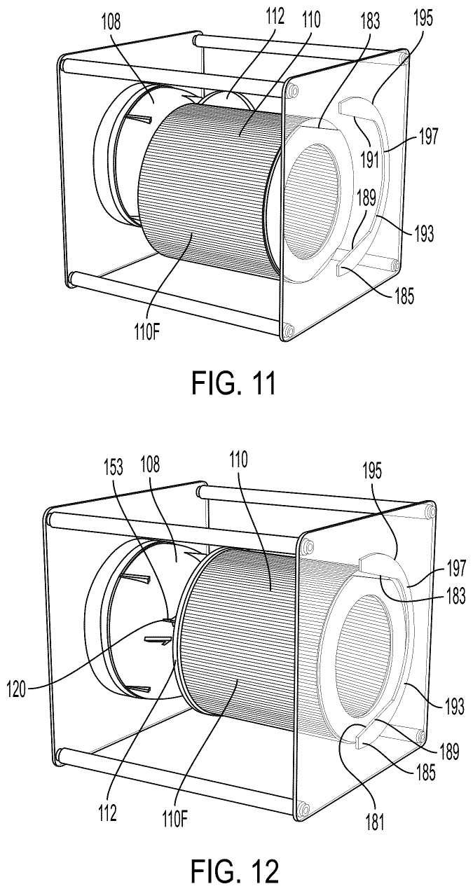

Referring to FIGS. 9 and 10, the housing 102 includes a guide 197 that is configured to enable the air purifier unit 110 to slide into position with respect to the sleeve 108 before actuating the actuator 120 to securely retain the air purifier unit 110. The guide 197 may be referred to as a filter guide. The guide 197 may include a semi-circular configuration with a circular outer surface 195 and with a circular inner surface 193. The circular inner surface 193 may include flat end portions 191, 189 at both its end portions 187, 185. The end cap 184 at the first end 172 of the air purifier unit 110HF includes complementary shaped flat end portions 183, 181 configured to engage with the flat end portions 191, 189 of the guide 197 as the air purifier unit 110 slides into the position with respect to the sleeve 108. FIGS. 11 and 12 show the filter 110F before and after being received by/engaged with the guide 197. FIG. 11 shows the filter 110F sliding into the guide 197. FIG. 12 shows the filter 110F fully seated in or engaged with the guide 197. The guide 197 is configured to keep the filter 110F in place (in the housing 102 and with respect to the sleeve 108) prior to the filter retaining step/procedure/operation.

One of the HEPA filter 110HF and the carbon filter 110CF are configured to be concentrically positioned with respect to the other of the HEPA filter 110HF and the carbon filter 110CF. In the illustrated embodiment, as shown in FIGS. 9-10, the carbon filter 110CF is concentrically positioned within the HEPA filter 110HF. A pre-filter or pre-filtering component may be configured to be concentrically positioned to surround the HEPA filter 110HF.

The carbon filter 110CF may be referred to as a carbon filter layer. The HEPA filter 110HF may be referred to as a HEPA filter layer. The carbon filter 110CF may reside on the outside of the HEPA filter 110HF. That is, the carbon filter 110CF may be configured to be concentrically positioned to surround the HEPA filter 110HF. A pre-filter may be configured to be concentrically positioned to surround the carbon filter 110CF and the HEPA filter 110HF (in that order). As will be appreciated by a POSITA, when the carbon filter 110CF is positioned on the outside of the HEPA filter 110HF, the HEPA filter 110HF and the carbon filter 110HF may also be combined so as to create an all in one replaceable filter.

A POSITA would also appreciate that these are just a few examples of various configurations and stratifications of the filtering layers. The configurations and stratifications of the filtering layers should not be limited to these configurations and stratifications of the filtering layers.

In one embodiment, the air purifier unit 110/filter 110F may include a pre-filter, the carbon filter 110CF, and the HEPA filter 110HF. The pre-filter may be configured to be concentrically positioned to surround the carbon filter 110CF and the carbon filter 110CF (along with the pre-filter) may be configured to be concentrically positioned to surround the HEPA filter 110HF. In such an embodiment, each of the pre-filter, the carbon filter 110CF, and the HEPA filter 110HF may have 1 year filter life.

The fan 104 is configured to move the air through the airflow path between the air inlet 114 and the air outlet 116. The fan 104 may be configured to pull the air through the air purifier 100 and to push the air out of the air purifier 100. The fan 104 may have a central opening 166 that is configured to receive the motor 106. The fan 104 may be configured to receive the motor 106 inside a ring/inner circumference of the fan 104. In use, the fan 104 is co-axial with the air purifier unit 110 and the motor 106.

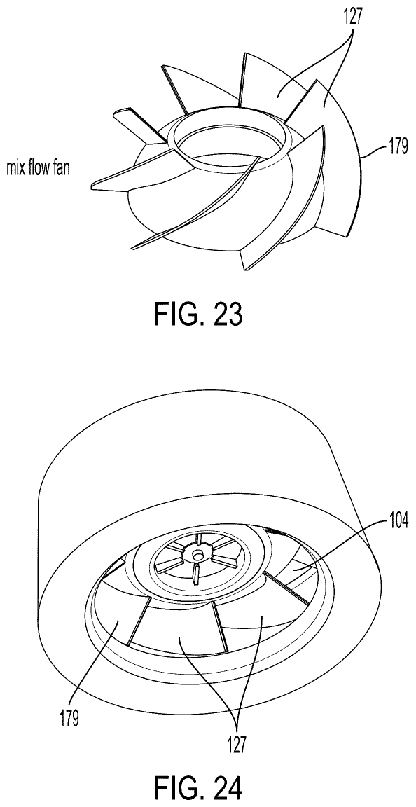

The fan 104 may be rotatably mounted in the housing 102. Referring to FIGS. 23-27, the fan 104 is a mixed flow fan in which the outflow of air is both axial and perpendicular to the inflow of the air. The fan 104 includes an impeller 179 and a plurality of impeller blades 127 disposed on the impeller 179. The mixed flow fan 104 is configured to twist the air flowing through the airflow path between the air inlet 114 and the air outlet 116. The fan 104 may draw air from the center and expels air out both radially and axially. The fan 104 may be configured to allow the air to enter the fan 104 around the area of a longitudinal axis of the fan 104 and allow the air to exit (i.e., spin the air outwards by deflection and centrifugal force) via the output opening 116.

The mixed flow fan 104 is configured to move air in-line similar to an axial fan but, due to the general 45-degree pitch, the air in the mixed flow fan 104 is configured to flow both axially and radially relative to the shaft and is configured to develop higher pressures than the axial fans with higher flow rates more efficiently than the centrifugal fans. By contrast, as would be appreciated by a POSITA, the centrifugal fan is configured to take in air in the center and the fan blades radiate air outwardly at right angles pushing the air towards a guide wall.

The fan 104 may configured to be operated at different fan speeds, or a continuous range of fan speeds. The different fan speeds may include turbo fan speed, high fan speed, medium fan speed, low fan speed, and sleep (e.g., at 0 rpm). The fan 104 may be operated at three, four or five different fan speeds. However, the fan speeds can vary significantly in number, or be continuously variable.

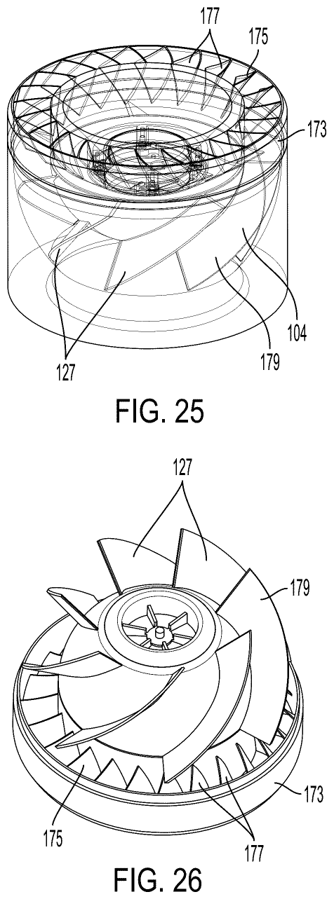

Referring to FIGS. 25-27, the air purifier 100 may include an outlet/exit flow guide structure 175. The outlet/exit flow guide structure 175 may include a plurality of outlet/exit guide vanes 177. The outlet/exit flow guide structure 175 may be part of an outlet guide vane housing 173. The outlet/exit flow guide structure 175 may be complementary to the structure/design of the mixed flow fan 104 so as to ensure that the exit flow of the air purifier 100 is redirected for efficiency, performance, and sound.

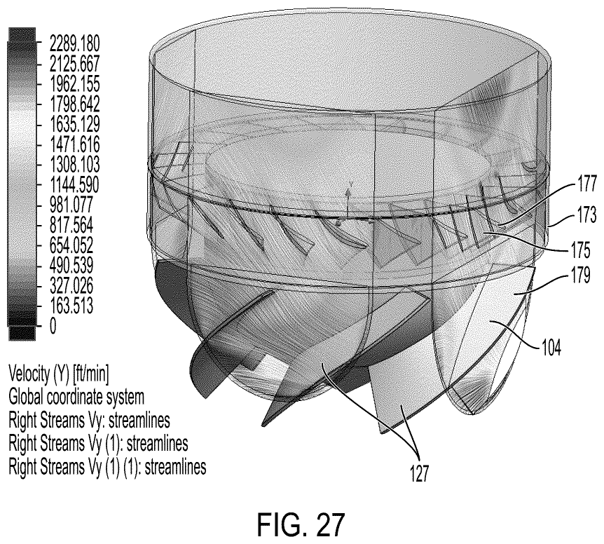

The plurality of outlet/exit guide vanes 177 is configured to convert some of the energy in the airflow from rotational velocity to a pressure increase. The plurality of outlet/exit guide vanes 177 increases the airflow volume achieved by the mixed flow fan 104 when significant resistance is applied to the intake (i.e., work required to pull air through the filter media 110F), and significant pressure differential may be generated from the fan intake to outlet. The plurality of outlet/exit guide vanes 177 and the fan blades 127 may be designed and configured to work together efficiently together and complement each other, which is what the Computational Fluidic Dynamic model in FIG. 27 confirms. Any fan at fixed rpm loses airflow as resistance increases, but the vaned design decreases this loss significantly vs. open air rated flow.

The motor 106 may be disposed in the central opening 166 of the fan 104 for rotating the fan 104. The motor 106 may be interchangeably referred to as a drive mechanism. The motor 106 may be configured to drive the fan 104 at variable speeds to move the air through the airflow path between the air inlet 114 and the air outlet 116.

The motor 106 may be configured to provide power to draw air into the air inlet 114, draw air through the airflow path and deliver/exhaust air out of the air outlet 116 of the housing 102.

The motor 106 may be an electric motor. The motor 106 may be a brushless DC (BLDC) motor. The motor 106 may be a battery operated motor. The motor 106 may include an output or motor shaft. The fan 104 may be operatively connected to the output shaft of the motor 106 to draw air into the air inlet 114, draw air through the airflow path and deliver/exhaust air out of the air outlet 116 of the housing 102. The motor 106 may be connected to a first end of the output or motor shaft and the fan 104 is connected to a second end of the output shaft. The air purifier 100 may also include a power switch and other electrical contacts for connecting a power cord from a source of electricity for operation of the air purifier 100.

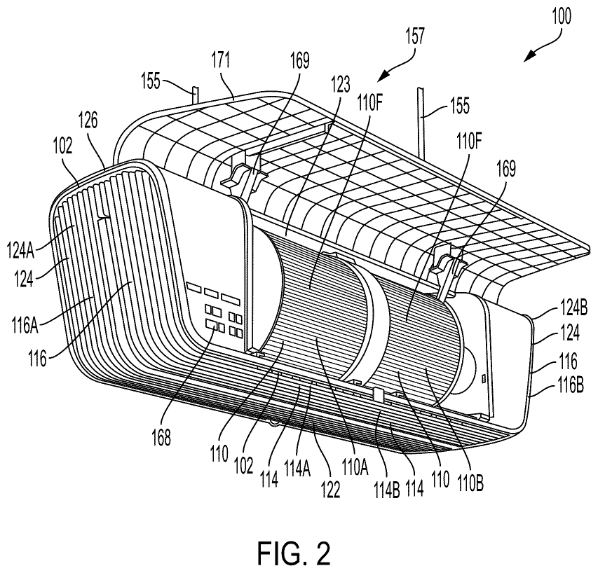

As shown in FIGS. 2-3 and 31-33, the panel 171 may be movably (or hingeably (e.g., using friction hinges 169 as shown in FIG. 2 or other types of hinges)) mounted to the housing 102. The panel 171 may be interchangeably referred to as a hinged door or a filler access panel.

The panel 171 may be movably attached to the top 126 of the housing 102. Referring to FIGS. 1 and 2, the panel 171 may be configured to be moved from a closed position, as shown in FIG. 1, in which the panel 171 covers the interior cavity 123 of the housing 102 (along with the fan 104, the motor 106, the retainer assembly 112, the air purifier unit 110, etc. contained/received therein) to an open position, as shown in FIG. 2, in which the panel 171 is configured to provide access to the air purifier unit 110 disposed in the interior cavity 123 of the housing 102 for installation or replacement of the air purifier unit 110. FIGS. 2 and 33 shows that the panel 171 in its open position so as to provide easy access to the air purifier unit 110.

The air purifier 100 may also include a security or vandal resistant lock on the panel 171 so as to resist attempts by thieves to gain access to internal components of the air purifier 100. In one embodiment, the panel 171 may be configured to receive the user interface 168 thereon.

In one embodiment, the filter access panel 171 may be removably attached to the housing 102 using fasteners such that removal of (the fasteners and) the filter access panel 171 from the housing 102 provides access to the air purifier unit 110.

The method/operation for installation or replacement of the air purifier unit 110 in the air purifier 100 may include a plurality of procedures, and these procedures are explained in detail with respect to FIGS. 1-2 and 9-16.

Referring to FIGS. 1-2, in a first procedure, when the filter change indicator 163 (including the HEPA filter replacement indicator 161 and/or a carbon filter replacement indicator 159) signals the user via the user interface 168 that the HEPA filter 110HF and/or the carbon filter 110CF needs replacing, the user may move the filter access panel 171 to its open position (in FIG. 2) so as to access the interior cavity 123 of the air purifier in which the air purifier unit 110 is disposed. In one embodiment, the user may have to unlock the security or vandal resistant lock on the filter access panel 171 to move the filter access panel 171 from its, closed position (in FIG. 1) to its, open position (in FIG. 2).

In the next procedure, the manually engageable actuator tab 153 of the actuator 120 is moved in the second direction SD (as shown in FIG. 16), this causes the actuator 120 of the air purifier 100 to be moved in the second direction SD from its second position (as shown in FIG. 16) in which the retainer 118 securely retains the air purifier unit 110 in the housing 102 of the air purifier 100 and with respect to the sleeve 108 to its first position (as shown in FIGS. 13-14) in which the retainer 118 does not engage with the air purifier unit 110. As explained in detail above, this movement of the actuator 120 in the second direction SD from its second position to its first position causes the air purifier unit 110 to be released from the retainer 118/retainer assembly 112.

The engagement between portions of the end cap 184 of the filter 110F and the filter guide 197 enables the air purifier unit 110 to be still held in position (i.e., fully seated in the filter guide 197 even though it is not retained by the retainer 118) with respect to the sleeve 108 even after the release of the retainer 118/retainer assembly 112 from the air purifier unit 110. The portions of the end cap 184 of the filter 110F are then disengaged from the filter guide 197, for example, by sliding the filter 110F outwardly away from the housing 102.

The user can then dispose components of the filter 110F or the complete filter 110F and install/replace with a new filter 110F or new components of the filter 110F. For example, if the life span of one of the HEPA filter 110HF and the carbon filter 110CF has been completed, while the life span of the other of the HEPA filter 110HF and the carbon filter 110CF still remains, then only the filter whose life span has been completed will be replaced. This is because of the removable connection between the HEPA filter 110HF and carbon filter 110CF as described in detail above.

A new filter 110F (including the HEPA filter 110HF and the carbon filter 110CF) is installed or replaced in the next procedures.

FIG. 9 shows the HEPA filter 110HF and the carbon filter 110CF before being connected to each other, FIG. 10 shows the HEPA filter 110HF and the carbon filter 110CF as they are being connected to each other, and FIG. 11 the HEPA filter 110HF and the carbon filter 110CF after they are connected to each other.

Referring to FIGS. 9 and 10, as described in detail above, the carbon filter 110CF and the HEPA filter 110HF may either be permanently or removably connected to each other based on their associated life spans. The first mating portion 180 (disposed on its first end cap 188 at the first end 176) of the carbon filter 110CF may be configured to engage with the second mating portion 182 (disposed on the first end cap 184 at the first end 172) of the HEPA filter 110H so as to (e.g., removably or permanently) connect the HEPA filter 110HF and the carbon filter 110CF together.

The new filter 110F (including the HEPA filter 110HF and the carbon filter 110CF connected to each other) is then slid towards the housing 102 and into place with respect to the sleeve 108. FIG. 11 shows the new filter 110F as it is being slid into place, while FIG. 12 show the new filter 110F fully seated in the filter guide 197 by engagement between portions of the end cap 184 of the filter 110F and the filter guide 197. This configuration in which the new filter 110F is fully seated in the filter guide 197 enables single handed operation during the installation or replacement of the filter 110F. This configuration also may be very useful in the air purifiers 100 that are installed in the ceiling, on the ceiling, or in upper portions of the wall that are not very easy to reach.

In the next procedure, the manually engageable actuator tab 153 of the actuator 120 is moved in the first direction FD (as shown in FIG. 16), this causes the actuator 120 of the air purifier 100 to be moved in the first direction FD from its first position (as shown in FIGS. 13-14) in which the retainer 118 does not engage with the air purifier unit 110 to its second position (as shown in FIG. 16) in which the retainer 118 securely retains the air purifier unit 110 in the housing 102 of the air purifier 100 and with respect to the sleeve 108. As explained in detail above, this movement of the actuator 120 in the first direction SD from its first position to its second position causes the air purifier unit 110 to be securely retained by the retainer 118/retainer assembly 112 in the housing 102 of the air purifier 100 and with respect to the sleeve 108.

The filter retention feature of the present patent application in which the actuator 120 is rotated is cammed tight with the retainer 118 so that the retainer 118 securely retains the air purifier unit 110. This configuration may be very useful for the air purifiers 100 that are ceiling mounted or mounted up high on the walls because they can be easily latched with one hand. The filter retention feature of the present patent application is more of a compression function, which is more frictional in function.

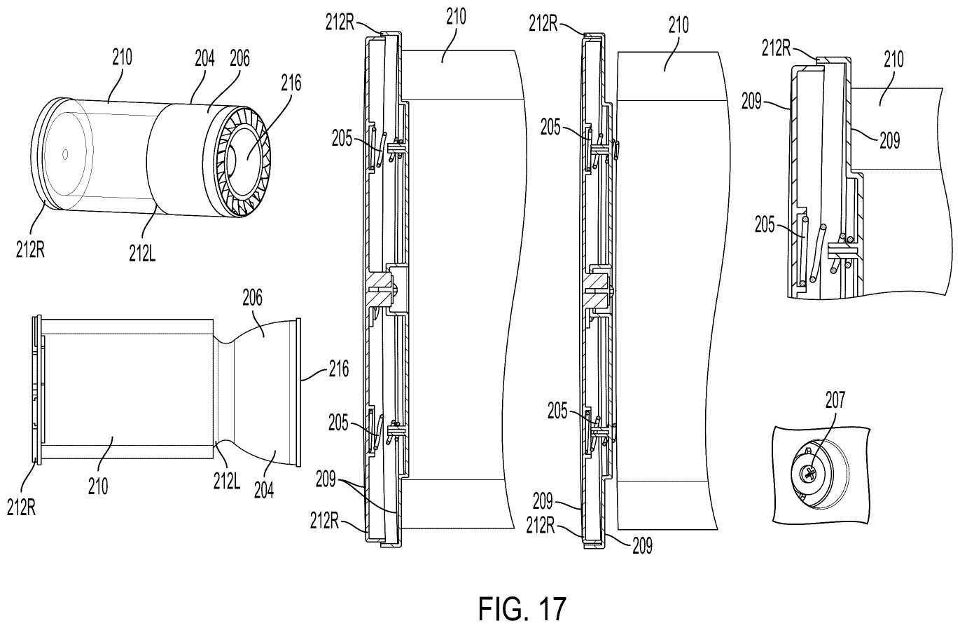

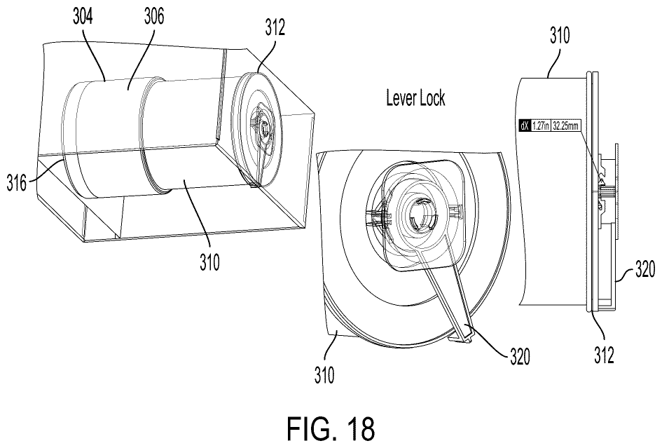

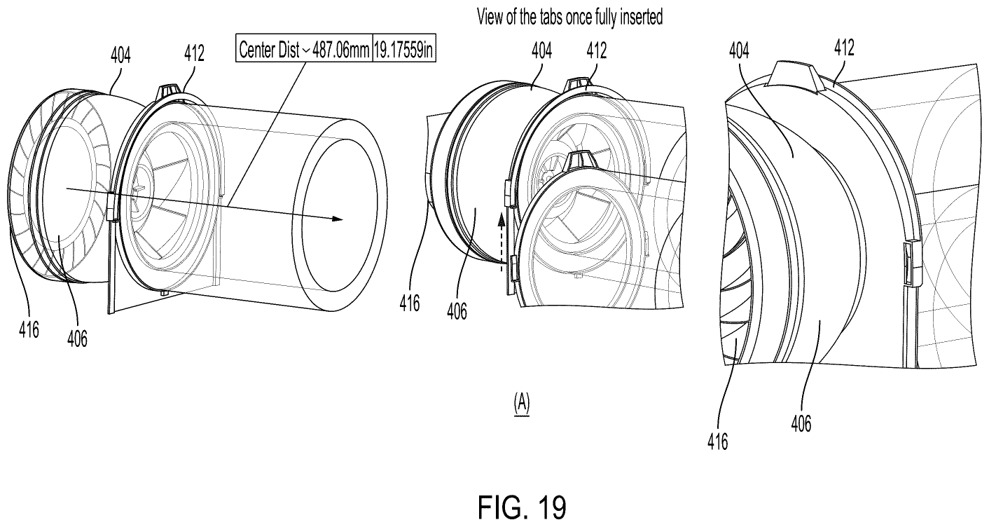

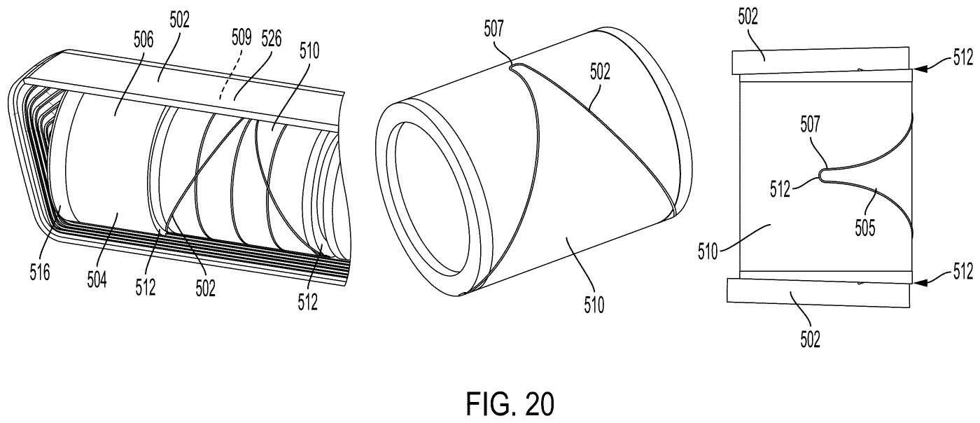

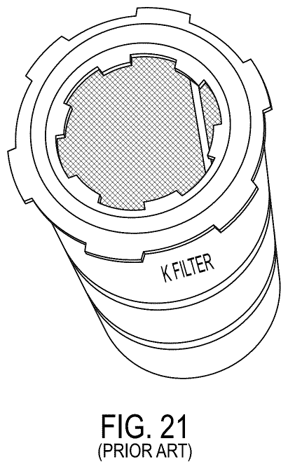

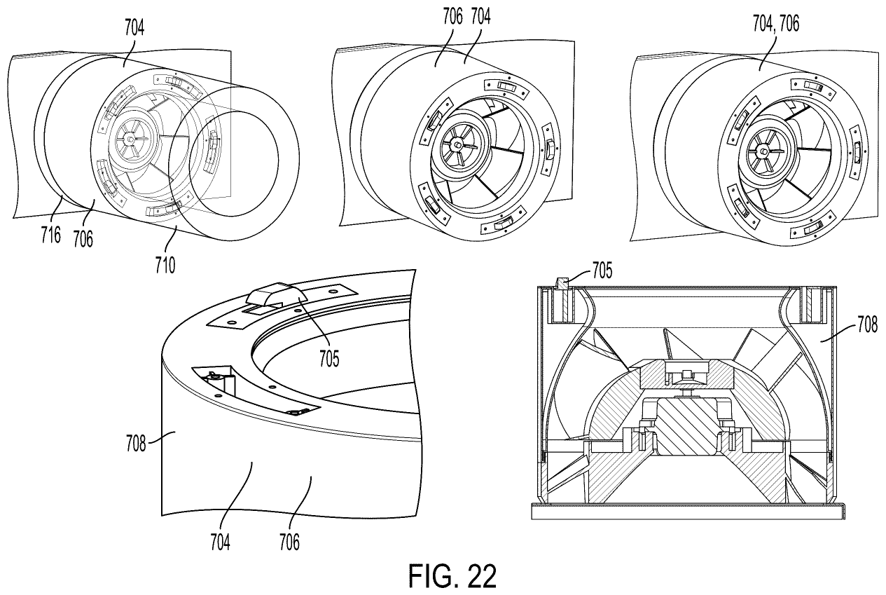

FIGS. 17-22 show the air purifier 100 using different retainer assemblies/mechanisms. For example, FIG. 17 shows a view of a spring plate retainer assembly/mechanism for an air purifier unit 110 of an air purifier 100, FIG. 18 shows a view of a lever retainer mechanism/assembly for an air purifier unit 110 of an air purifier 100, FIG. 19 shows a view of a tab engagement retainer assembly/mechanism for an air purifier unit 110 of an air purifier 100, FIG. 20 shows a view of a spring based and tapered retainer assembly/mechanism for an air purifier unit 110 of an air purifier 100, and FIG. 22 shows a view of another spring biased retainer assembly/mechanism for an air purifier unit 110 of an air purifier 100. FIG. 21 shows an exemplary air purifier unit 110 having portions that are configured to engage with portions of a retainer assembly 112 of the air purifier 100.

FIG. 17 shows the engine/core with fan 204, motor 206, air purifier unit 210, and the output opening 216. The retainer assembly 212L is positioned on one end of the air purifier unit 210 that is adjacent to the motor 206 and the fan 204. A support structure 212R is positioned on the other end of the air purifier unit 210 that is not adjacent to the motor 206 and the fan 204. The support assembly 212R may include one or more springs 205, an anti-rotation feature 207, and a plurality of members 209 together enclosing the springs 205. The support assembly 212R is configured to control the orientation by a center rib feature. A and C in FIG. 17 show a filter installed configuration in which the members 209 of the support assembly 212R are spaced apart and the springs 205 are in their expanded configuration. B in FIG. 17 shows a filter removal configuration in which the members 209 of the support assembly 212R are their overlapped configuration and the springs 205 are in their compressed configuration. The filter sensing PCB may be mounted on the air purifier unit 210. C in FIG. 17 shows a total width impact of the filter holding/support assembly 212R is 20.4 or 21 millimeters (mm).

In the embodiment of FIG. 17, the support assembly 212R on one end of the air purifier unit 210 allows for compression as the air purifier unit 210 is pushed towards the support assembly 212R releasing the opposing end of the air purifier unit 210 from the retainer assembly 212L (e.g., with plate with a retaining ring). The compression of the support assembly 212R would be greater than the protruding retaining ring 212L allowing the air purifier unit/filter 210 to then be pulled out when compressing the support assembly 212R.

FIG. 18 shows the engine/core with fan 304, motor 306, air purifier unit 310, and the output opening 316. The retainer assembly 312 is positioned on an end of the air purifier unit 310 that is not adjacent to the motor 306 and the fan 304. The retainer assembly 312 may include a lever handle/lock 320 and a retainer 318. The operation of the lever lock 305 may include rotation of the lever handle 320 from a first portion to a second position and may be similar to the operation of the actuator 120. The retainer 318 may have structure and operation that is similar to the retainer 118 described in other embodiments. In this embodiment, a single-handed operation may be performed, with minimal motion exerted on the housing 102. The lock handle may be situated to block access door if no filter is installed. The filter sensing PCB may be mounted either on the front or on the rear of the filter unit 310. This embodiment does require use bulky molded caps on the air purifier unit 310.

FIG. 19 shows the engine/core with fan 404, motor 406, air purifier unit 410, and the output opening 416. The retainer assembly 412 is positioned on an end of the air purifier unit 410 that is adjacent to the motor 406 and the fan 404. The air purifier unit 410 includes (plastic) top and bottom (end) cap. The air purifier unit 410 may be mounted directly to the fan assembly, removing the need for a supporting structure at the other end (freeing up some axial space). In this configuration/embodiment, one of the end cap of the air purifier unit 410 may include protruding tabs requiring insertion in the direction shown, sliding across the face of the fan assembly. In the last inch or so, the hooks on either side snug the faces up against each other. The protruding tabs on the end cap of the air purifier unit 410 flex into corresponding retaining shape with sidewalls. When the protruding tabs align with the supportive retainers, the protruding tabs flex back to their natural state locking the air purifier unit/filter 410 into position. The most accessible tab, which corresponds to the inserting direction, can be the key tab retainer in which the operator presses upon to release the key tab, allowing the air purifier unit/filter 410 to be pulled out overcoming the retaining force placed upon the other tab retainers.

A in FIG. 19 shows the tabs being fully inserted. The act of inserting purifier unit 410 utilizing the tabs and corresponding receivers compresses the sealing gasket ensuring the air purifier element is inserted correctly.

FIG. 20 shows the engine/core with fan 504, motor 506, air purifier unit 510, and the output opening 516. A retainer assembly 512 is positioned on both ends of the air purifier unit 510. The retainer assembly 512 may include tapered portions of the air purifier unit 510 and the housing 502 and a formed spring 505. The air purifier unit 510 includes tapered portions on both ends, and the housing 502 has opposite/complementary tapered portions. This engagement of the tapered portions of the air purifier unit 510 and the housing 502 ensures a proper seal once the air purifier unit 510 is installed in the housing 502. C in FIG. 20 shows the tapered portions on both ends of the air purifier unit 510 and the housing 502. The formed spring 505 is configured to swing open and snap into top of the housing 502 when closed. The top portion 507 of the formed spring 505 may be locked into the tab on the housing 502 and pressure of the spring 505 would keep the air purifier unit 510 sealed. Thin nature of the spring 505 is configured to have negligible effect on the airflow. FIG. 20 shows a bent wire filter retainer in which the top portion 507 goes over a corresponding hook 509 assembled within (e.g., the top 526 of) the housing 502, the distal ends from top portion 507 of the spring 505 are bent outwardly so as to function like hinges having the protruding outwardly bent ends retained by (e.g., the top 526 of) the housing 502. A receiving rib with the hook 509 engages wire formed filter retainer return top portion 507 of the spring 505.

FIG. 21 shows prior art air purifier unit with filter retention portions that are configured to engage with an improved filter retention mechanism of the present patent application as shown in FIG. 22. That is, the improved filter retention mechanism of the present patent application as shown in FIG. 22 may be used with the prior art air purifier unit as shown in FIG. 21.

FIG. 22 shows a “twist lock” similar to a bayonet mount, with the twisting locking sealing the air purifier to a flat receiving surface. The engine/core with fan, motor, air purifier unit 710, and the output opening 716 are shown in FIG. 22. The retainer assembly 712 is positioned on an end of the air purifier unit 710 that is adjacent to the motor 706 and the fan 704. FIG. 22 shows the improved assembly includes engagement portions 705 that are spring biased outwardly from the sleeve 708 and configured to engage with portions (e.g., in the end caps) of the air purifier unit 710 to retain the air purifier unit 710 with respect to the sleeve 708. The embodiment allows for different filter axial lengths. The filter sensing PCB may be mounted on the filter unit 710. It functions similarly to a bayonet type mount with the added improvement of a sealing and retention feature.

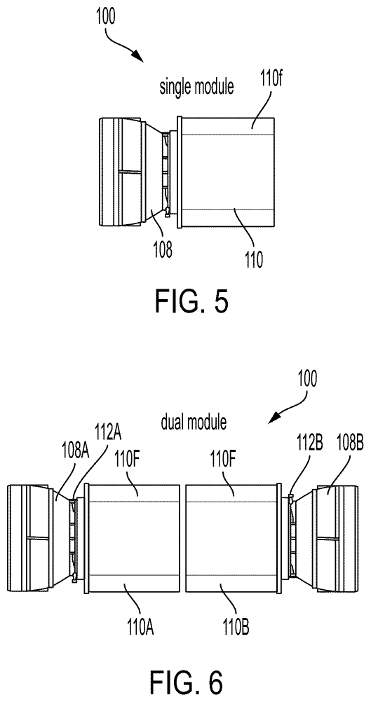

The single core/engine configuration, as shown in FIGS. 4-5, of the air purifier 100 may include one air channel, a single fan 104, a single motor 106, a single retainer assembly 112, a single air purifier unit 110 and a single output opening 116.

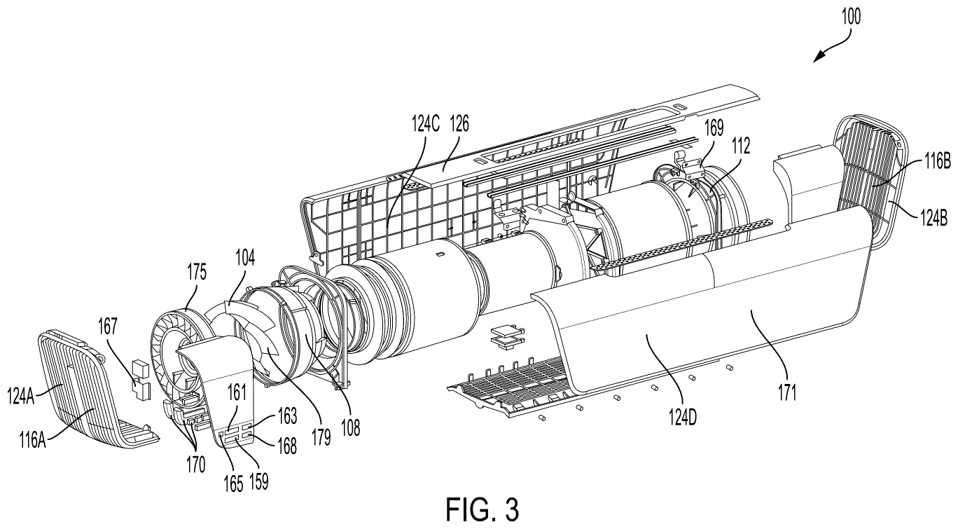

Referring to FIGS. 3 and 6, the dual or two core/engine configuration of the air purifier 100 may include two air channels, two fans 104, two motors 106, two retainer assemblies 112A, 112B, two air purifier units 110A, 110B and two output openings 116A, 116B. The two air purifier units 110A, 110B in the dual core configuration are positioned adjacent to each other but slightly spaced apart so as to enable replacement/installation of the respective air purifier unit 110A, 110B. The two output openings 116A, 116B are positioned on opposing ends of the dual core/engine air purifier 100. The dual core/engine air purifier 100 may include a single housing and a single controller and sensor arrangement. The dual core/engine air purifier 100 may include a single housings and two separate controller and sensor arrangements. The dual core/engine air purifier 100 may include two separate housings and two separate controller and sensor arrangements.

The fan 104 may optimally include strong performance and pressure values and is configured to reduce the possibility of stalling. Applicant of the present patent application has found that the mixed flow fan 104 was found to work for this type of use.

FIG. 29 shows a prior art graphical representation of pressure vs airflow through an air purifier when an axial fan is used in the air purifier. In FIG. 29, the static pressure (measured in pound per square inch (PSI)) is shown in the Y-axis and the airflow (measured in Cubic Feet per Minute (CFM) is shown in the X-axis. A “stall region” is shown in FIG. 29. In the stall region, a small increase in resistance or suction leads a large reduction in flow.

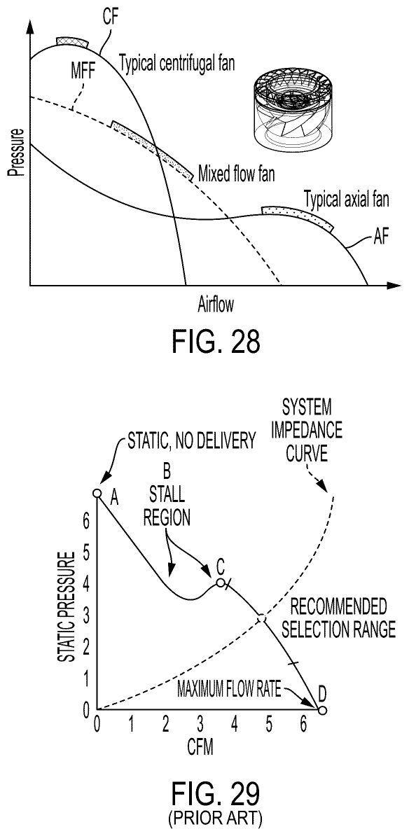

Mixed flow fan 104 of the present patent application does not have stall region characteristic of the prior art axial (vane-axial) fan. FIG. 28 shows comparative graphical representations of pressure vs airflow through an air purifier, for example, when a centrifugal fan, a mixed flow fan or an axial fan, respectively is used in the air purifier. In FIG. 28, the static pressure (measured in PSI) is shown in the Y-axis and the airflow (measured in CFM) is shown in the X-axis. For example, CF shows pressure vs airflow representation through an air purifier having a centrifugal fan, MFF shows pressure vs airflow representation through the air purifier 100 of the present patent application having the mixed flow fan 104, and AF shows pressure vs airflow representation through an air purifier having an axial fan. As shown in MFF in FIG. 28, the mixed flow fan 104 of the present patent application does not have stall region characteristic of the prior art axial (vane-axial) fan.

The present patent application provides a high performance air processing core that includes the mixed flow fan 104, the motor 106, the exit guide vane structure 175, and the filter 110F, and the filter retainer assembly/mechanism 112 allowing for varied housing configurations for varied applications. The varied applications may include on ceiling configuration, in ceiling configuration, drop down/hanging from ceiling configuration, on wall configuration, in wall configuration, and floor standing (tower) configurations. For example, shared filters across multiple air purifier models may ensure consistent experience for users and may also decrease the number of different filters required to support the different models of the air purifiers. The shared core engine design may provide design and agency certification efficiency and consistency across the different models of the air purifiers.

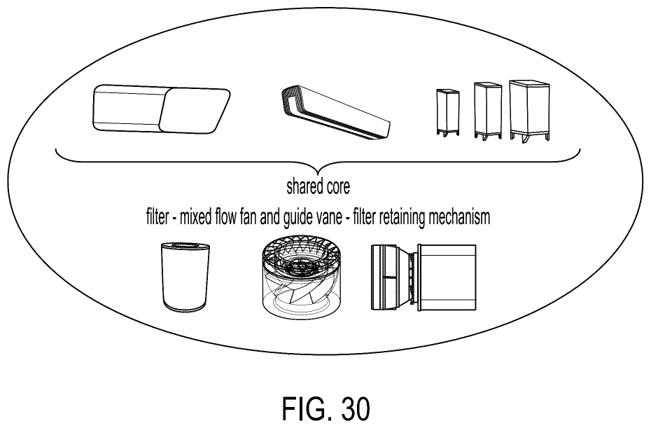

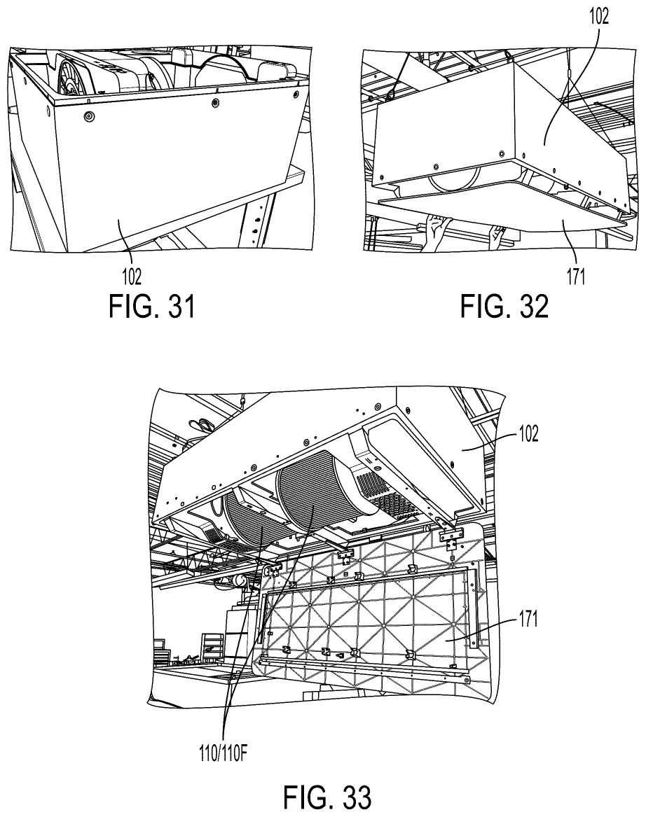

FIG. 30 shows a shared core configuration (e.g., including the air purifier unit/filter 110/110F, the mixed flow fan 104, the motor 106, the outlet/exit flow guide structure 175, and the retainer assembly 112 for the air purifier unit/filter 110/110F) being used across different models/configurations of the air purifier 100 including on and in ceiling/walls, hanging from the ceiling/wall, on and in wall, and floor standing configurations. For example, FIGS. 1-2 show the air purifier 100 that hangs from the ceiling 157 using cables 155. The cables 155 may be aircraft cables. The air purifier 100 may optionally have a motorized lowering unit that is configured to lower the air purifier 100 for service/maintenance. FIGS. 31-33 show exemplary prototypes of the ceiling mounted air purifier 100 in accordance with an embodiment of the present patent application. FIG. 31 shows an air purifier with a single core/module configuration, FIG. 32 shows an air purifier with dual core/module configuration, and FIG. 33 shows the air purifier with the dual core/module configuration in which the panel 171 of the air purifier is moved to its open position for installation or replacement of its air purifier unit/filter 110/110F.

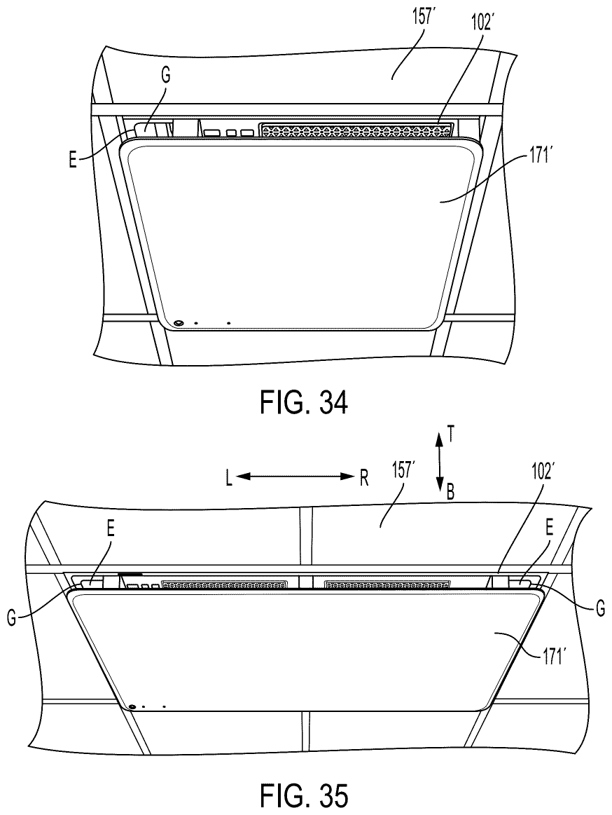

FIGS. 34-35 show exemplary air purifiers mounted in the ceiling 157′ in accordance with an embodiment of the present patent application, where FIG. 34 shows an air purifier with a single core/module configuration that may be configured to deliver 300 CFM and to have maximum noise levels ranging from about 54 to about 59 decibels (dB). FIG. 35 shows an air purifier with dual core/module configuration that may be configured to deliver 600 CFM and to have maximum noise levels ranging from about 55 to about 60 decibels (dB).

As shown in FIG. 34-35, the filter access panel 171′ may be removably attached to the housing 102′. The filter access panel 171′ may have intake vents thereon for the inflow of air. When the filter access panel 171′ is removably attached, the air purifier 100 provides gaps G at side edges E thereof. The plenum of the air purifier 100 may be positioned adjacent the gap G for directing the outflow of air through the gaps G. The air purifier 100 may be positioned along a direction of the arrow L-R. Although the gap G is shown at the left and right side edges E, the gap G may be positioned at other side edges E. In such an embodiment, the air purifier 100 may be positioned along a direction of the arrow T-B. The gap G may be an outflow vent.

The air purifier 100 may be positioned or installed in a targeted zone. The targeted zone, herein, refers to a defined closed space (e.g., offices, homes, conference rooms) or a defined semi-closed space (e.g., lobby). For example, the targeted zone may include an enclosed environment. The targeted zone may also be a sub-section of a larger space, such as a set of office cubicles or like.

The air purifier 100 may be configured to deliver 300 Cubic Feet per Minute (CFM) at 1500 Rotations per Minute (RPM). The air purifier 100 may be configured to deliver 625 CFM. The air purifier 100 may be configured to have maximum noise levels ranging from about 55 to about 59 decibels (dB).

The air purifier 100 may be configured to be controlled via wi-fi and/or Bluetooth.

The air purifier 100 may be mounted on a vertical surface like a wall or on a horizontal surface like a ceiling so that the air purifier 100 does not take up the floor space. The air purifier 100 may also be mounted on the floor. The air purifier 100 may be free standing on the floor using a stand. The air purifier 100 may be mounted in a wall or a ceiling. Although air purifiers may be mounted in/on vertical surfaces like walls or horizontal surfaces like ceilings, they are generally not positioned that way (i.e., no need to position them that way). As would be appreciated by a person of ordinary skill in the art, the air purifier 100 may be mounted on the wall/ceiling using a bracket member (not shown) and one or more fastening members for mounting the bracket member to the wall/ceiling.

The air purifier 100 may include a sensor that is disposed in or on the housing 102. The sensor may be configured to monitor one or more conditions in a predetermined area proximate the air purifier 100 to detect presence or movement of an object in the predetermined area. In another embodiment, the sensor may also be configured to sense other conditions in the predetermined area.

Referring to FIGS. 1-2, the air purifier 100 may include an air purity or air quality sensor that is configured to monitor the air quality. In one embodiment, the air quality sensor may be a particle sensor 167 as shown in FIG. 3. The air purity or air quality sensor may be configured send an output signal (air quality/purity signal) to a controller of the air purifier 100. The controller of the air purifier 100, in response to the received air quality/purity signal from the air purity or air quality sensor, either may automatically adjust the fan speed or may notify the user about the air quality using an air quality indicator 165. The air quality indication may include a graphical representation, visual (percentage, number or a changing color), audio signal or any other communications channels.

FIGS. 1 and 2 also show that the air purifier 100 may include a service light/indicator that alerts/signals the user (via the user interface by flashing or otherwise) when the air purifier 100 needs either maintenance or repair. The air purifier 100 may include filter change indicator 163 that signals the user via a user interface 168 when the HEPA and carbon filters 110HF, 110CF need replacing. For example, the air purifier 100 may include a HEPA filter replacement indicator 161 and a carbon filter replacement indicator 159.

The air purifier 100 may also include other sensors and their corresponding indicators. The air purifier 100 may include a plurality of control and/or comfort sensors. The sensors may include, but not limited to, Indoor Air Quality (IAQ) sensor, Particulate Matter (PM) sensor, Temperature sensor, Relative Humidity (RH) sensor, Carbon Dioxide (CO₂) sensor, Total Volatile Organic Compounds (TVOC) sensor, a motion sensor, an audio/sound sensor, a light sensor, a pressure sensor, etc. The PM sensor may be a PM2.5 sensor.

For example, the air purifier 100 may also include a Powered filtering component filter replacement indicator, a sleep mode indicator to indicate that the air purifier is in a sleep mode, a motion sensor indicator to indicate the detection of the object by the motion sensor, an audio sensor indicator to indicate the detection of the object by the audio sensor, odor level indicators that provide feedback to the user regarding the odor level sensed by the odor sensor, etc.

The controller of the air purifier 100 may include a control circuit. However, the controller may alternatively include any other type of suitable controller without deviating from the scope of the present patent application. For example, the controller may include a processor executing code; an integrated computer system running a program; analog or digital circuitry; etc.

The controller may be configured to be in communication with the sensor to receive the sensor inputs. The controller, based on the received sensor inputs, may also be configured to control the operation of the air purifier 100. The controller may be configured to be in communication with the motor 106 and the fan 104 to control the operation of the air purifier 100. Such a sensor and a controller/control system are described in detail in the '842 Patent and will not be described in detail here.

The air purifier 100 may be configured to detect the presence of other air purifier(s) within its given proximity and within the targeted zone. For example, using Infrared (IR) emitters and receivers or other wired or wireless signal systems (e.g., Near Field Communication (NFC), Local Area Network (LAN), Wireless Local Area Network (WLAN), Bluetooth, RF, Wi-Fi etc.), other air purifiers 100 within a given proximity of the air purifier 100 are detected so as to allow one of the air purifiers 100 to be designated as the master and the other subsequent air purifiers 100 to be designated as the slaves. This ‘master-slave’ arrangement allows for simple control of multiple air purifiers 100 within a given environment. For example, the air purifier 100 recognizes the presence of other air purifiers 100 and coordinates the controllers to work together to optimally clean the air in the targeted zone. Such master slave arrangement is described in detail in the '842 Patent.

The air purifier 100 may include a user interface 168 (e.g., FIGS. 2-3) that is operatively connected to a controller 170 and is configured to display information (e.g., operational performance) of the air purifier 100 to a user and/or solicit information as well as allow a user to enter data and/or other parameters of the air purifier 100. The user interface 168 may be disposed on the housing 102.

The user interface 168 may allow a user to modify one or more parameters of the air purifier 100. For example, the user interface 168 may be display such as a graphical display. The display may be a touch screen display or a liquid crystal display (LCD) display. Also, the user interface 168 may include one or more buttons or other controls that allow a user to modify one or more parameters of the air purifier 100. For example, the one or more buttons or other controls of the user interface 168 may be operated by touch or tactile manipulation or mechanical type control.

In one embodiment, the user interface 168 may be configured to be removably attached to the air purifier 100 such that the user interface 168 is configured to reside on the air purifier 100 and function as the primary user interface. The user interface 168 may be configured to be removed from the air purifier 100 and configured to be placed at a remote location. In such an embodiment, the user interface 168 may be configured to be operated from the remote location. The remote location may refer to a location that is remote from the air purifier 100. The user interface 168 may include a rechargeable power supply that is configured to be charged when the user interface 168 is attached to the air purifier 100. The user interface 168 and the air purifier 100 may be communicated by wired or wireless signals when the user interface 168 is disconnected and remote.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. An air purifier comprising:
a housing comprising an intake opening for an inflow of air and an output opening for an outflow of air;
a fan;
a motor for rotating the fan;
a sleeve configured to at least partially surround the fan and/or the motor;
an air purifier unit mounted in the housing purifying air flowing through the housing, the air purifier unit operatively coupled to the sleeve; and
a retainer assembly configured to retain the air purifier unit in the housing and with respect to the sleeve, the retainer assembly comprising:
a retainer; and
an actuator operatively associated with the retainer and the sleeve, wherein movement of the actuator from a first position to a second position moves the retainer to securely retain the air purifier unit in the housing.

2. The air purifier of claim 1, wherein the actuator is an actuator ring having a ring shaped configuration, and
wherein the actuator includes an engagement member disposed thereon.

3. The air purifier of claim 2, wherein the actuator is configured to be movable/rotatable with respect to the sleeve,
wherein the retainer assembly further comprises a guide disposed on the sleeve, and
wherein the guide is configured to receive the engagement member of the actuator therein such that the engagement member of the actuator slidably engages with surfaces of the guide during the movement of the actuator between the first position to the second position.

4. The air purifier of claim 3, wherein, when the actuator is in the first position, the retainer is in a first position in which the retainer does not engage with the air purifier unit, and
wherein, when the actuator is moved to the second position, the retainer is moved to a second position in which the retainer securely retains the air purifier unit in the housing.

5. The air purifier of claim 4, wherein rotation of the actuator from the first position to the second position advances the retainer against a portion of the air purifier unit to securely retain the air purifier unit in the housing and with respect to the sleeve.

6. The air purifier of claim 5, wherein the portion of the air purifier unit is a sealing portion.

7. The air purifier of claim 6, wherein the retainer is a compression ring that is configured to securely retain the air purifier unit.

8. The air purifier of claim 1, wherein the actuator is an actuation lever.

9. The air purifier of claim 1, wherein the housing comprises a guide configured to enable the air purifier unit to slide into position with respect to the sleeve before actuating the actuator to securely retain the air purifier unit,
wherein the guide includes a semi-circular configuration with a circular outer surface and with a circular inner surface and flat end portions, and
wherein a first end of the air purifier unit includes complementary shaped flat end portions configured to engage with the flat end portions of the guide as the air purifier unit slides into the position with respect to the sleeve.

10. The air purifier of claim 1, the air purifier unit comprises a filter,
wherein the filter has a cylindrical shaped configuration, and
wherein the retainer assembly is configured to retain the filter.

11. The air purifier of claim 10, the air purifier unit includes a High Efficiency Particulate air (HEPA) filter and a carbon filter.

12. The air purifier of claim 11, wherein the HEPA filter has a first end and an opposing second end,
wherein the carbon filter has a first end and an opposing second end, and
wherein the first end of the carbon filter includes a first mating portion configured to engage with a second mating portion on the first end of the HEPA filter so as to removably connect the HEPA filter and the carbon filter.

13. The air purifier of claim 11, wherein the HEPA filter and the carbon filter are configured to be concentrically positioned with respect to each other, and
wherein the carbon filter is concentrically positioned within the HEPA filter.

14. The air purifier of claim 13, further comprises a pre-filter that is concentrically positioned to surround the HEPA filter.

15. The air purifier of claim 1, wherein the fan is a mixed flow fan in which the outflow of air is both axial and perpendicular to the inflow of the air.

16. The air purifier of claim 2, wherein the fan includes an impeller and a plurality of impeller blades disposed on the impeller.

17. The air purifier of claim 2, further comprising an outlet/exit flow guide structure, and wherein the outlet/exit flow guide structure includes a plurality of outlet/exit guide vanes.

18. The air purifier of claim 2, wherein, in use, the air purifier unit is essentially co-axial to the fan and/or the motor.

19. The air purifier of claim 1, wherein the air purifier includes dual core configuration having two fans, two motors, two air purifier units, and two retainer assemblies,
wherein, in each core of the dual core configuration, the air purifier unit is essentially co-axial to the associated fan and/or the associated motor.

20. The air purifier of claim 2, wherein the retainer assembly further comprises a guide ring that is assembled to the sleeve,
wherein the actuator is configured to be movable/rotatable with respect to the sleeve and the guide ring,
wherein the retainer assembly further comprises a guide,
wherein angular camming ramps on the sleeve and angular camming ramps on the guide ring form the guide, and
wherein the guide is configured to receive the engagement member of the actuator therein such that the engagement member of the actuator slidably engages with the angular camming ramps of the guide during the movement of the actuator between the first position to the second position.
